(19) United States
(12) Patent Application Publication
(10) Pub. No.: US 2004/0100573 A1
(43) Pub. Date: May 27, 2004

(54) Focusing apparatus and camera including the same

(76) Inventor: Osamu Nonaka, Sagamihara-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 10/715,710

(22) Filed: Nov. 18, 2003

(30) Foreign Application Priority Data
Nov. 21, 2002 (JP) 2002-338002
Dec. 11, 2002 (JP) 2002-359503
Dec. 17, 2002 (JP) 2002-365416

(51) Int. Cl. H04N 5/232

(52) U.S. Cl. 348/345

(57) ABSTRACT

A focusing apparatus comprises a distance-measuring device which measures distances of a plurality of points in a photographing field, a photographing lens, a driving mechanism which drives the photographing lens along an optical axis, an image pickup device which receives a subject light flux incident via the photographing lens to output a subject image signal, and a CPU which controls the driving mechanism to drive the photographing lens along the optical axis, while detecting a contrast of the subject image signal in a plurality of image pickup areas corresponding to the plurality of points and which adjusts a focal position of the photographing lens in a position which has a highest contrast of the subject image signal in an image pickup area corresponding to a point indicating a shortest distance of an output of the distance-measuring device in the plurality of points.

### CROSS-REFERENCE TO RELATED APPLICATIONS

This application is based upon and claims the benefit of priority from the prior Japanese Patent Applications No. 2002-338002, filed Nov. 21, 2002; No. 2002-359503, filed Dec. 11, 2002; and No. 2002-365416, filed Dec. 17, 2002, the entire contents of all of which are incorporated herein by reference.

### BACKGROUND OF THE INVENTION

1. Field of the Invention

The present invention relates to a focusing apparatus of a photographing lens of a so-called electronic camera which uses image pickup devices such as a CCD and CMOS sensor to photograph a subject, and to a camera including this focusing apparatus.

2. Description of the Related Art

In a field of a camera using a silver salt film, a focusing method of a so-called open loop system has been used in which a subject distance is obtained and a lens position is adjusted from a relation between a distance determined beforehand by design and a lens position. However, in an electronic camera, an image signal is easily obtained as an electric signal by an image pickup device disposed in a position corresponding to a film surface position. Therefore, a focus has been adjusted in a so-called feedback control for driving a photographing lens based on the image signal to bring the lens in a position where contrast is maximized. In general, this focusing system is called mountain climbing AF.

Moreover, a technique concerning the mountain climbing AF using the above-described feedback method is disclosed in Jpn. Pat. Appln. KOKAI Publication No. 2001-255450. In this technique, the above-described system is applied with respect to a plurality of points in a photographing field, and correct focusing is possible regardless of a composition at the time of the photographing.

Furthermore, another technique is disclosed in Jpn. Pat. Appln. KOKAI Publication Nos. 2001-141985, 2001-249267, and 11-23955. This technique is a combined technique of the mountain climbing AF and an external metering AF by a distance-measuring equipment using an optical system disposed separately from the photographing lens. Accordingly, a release time lag can be reduced as compared with the focusing only by the mountain climbing AF.

Still another technique is disclosed in Jpn. Pat. Appln. KOKAI Publication No. 2001-350170. This technique is a technique for irradiating a subject with a flash light at the time of the mountain climbing AF.

### BRIEF SUMMARY OF THE INVENTION

According to a first aspect of the present invention, there is provided a focusing apparatus comprising:

a distance-measuring device which measures distances of a plurality of points in a photographing field;

a photographing lens;

a driving mechanism which drives the photographing lens along an optical axis;

an image pickup device which receives a subject light flux incident via the photographing lens to output a subject image signal; and

a CPU which controls the driving mechanism to drive the photographing lens along the optical axis, while detecting a contrast of the subject image signal in a plurality of image pickup areas corresponding to the plurality of points and which adjusts a focal position of the photographing lens in a position which has a highest contrast of the subject image signal in an image pickup area corresponding to a point indicating a shortest distance of an output of the distance-measuring device in the plurality of points.

According to a second aspect of the present invention, there is provided a focusing apparatus comprising:

a distance-measuring device which measures distances of a plurality of points in a photographing field;

a photographing lens;

a driving mechanism which drives the photographing lens along an optical axis;

an image pickup device which receives a subject light flux incident via the photographing lens to output a subject image signal;

an image processing section which processes the subject image signal outputted from the image pickup device; and

a CPU which selects the specific area based on a part of an output of the distance-measuring device and which operates the driving mechanism to execute a mountain climbing AF operation in accordance with a contrast of the subject image signal in a specific area.

According to a third aspect of the present invention, there is provided a focusing apparatus comprising:

an image pickup device including a plurality of image pickup areas;

a focusing lens including an optical path via which a subject light flux is incident upon the image pickup device;

a focusing section which determines a plurality of focusing lens positions from a relation between the position of the focusing lens and a contrast of a subject image signal obtained on the image pickup device via the focusing lens;

a distance-measuring section which obtains the position of a subject in a photographing field and a distance to the subject by the subject light flux incident via an optical path different from that of the focusing lens; and

a calculation control section which obtains a plurality of combinations of the focusing lens position and the image pickup area for use at the time of the focusing by the position and distance of the subject obtained by the distance-measuring section.

According to a fourth aspect of the present invention, there is provided a focusing apparatus comprising:

a photographing lens;

an image pickup section which detects a subject image incident via the photographing lens;

an optical system which is different from the photographing lens;

a distance-measuring section which uses the optical system different from the photographing lens to measure a subject distance of a plurality of points in a photographing field; and

a determining section which focuses the photographing lens on a plurality of focal positions corresponding to a plurality of distance measurement results of the distance-measuring section and which determines an area to execute a mountain climbing AF based on contrasts obtained by the focusing and the distance measurement results.

According to a fifth aspect of the present invention, there is provided a camera including a focusing apparatus, comprising:

an irradiation device which selectively switches irradiation and non-irradiation of a subject with an auxiliary light for distance measurement;

a photographing lens;

a driving circuit which drives the photographing lens along an optical axis direction;

an image pickup device which receives a light flux incident from the subject via the photographing lens to output a subject image signal;

an image processing circuit which processes the subject image signal outputted from the image pickup device;

a distance-measuring device which includes a pair of optical systems and a pair of sensors for distance measurement to detect a plurality of subject images incident via the pair of optical systems and which outputs information associated with a subject distance based on the plurality of subject images detected by the sensors for distance measurement and which detects the plurality of subject images in a case where the subject has a low brightness; and

a CPU which selectively executes a first auto-focus operation of detecting a contrast state based on the subject image signal processed by the image processing circuit to adjust a focus of the photographing lens, a second auto-focus operation of performing a distance-measuring operation by the distance-measuring device in a non-irradiation state of the auxiliary light for distance measurement to adjust the focus of the photographing lens in accordance with a result of the distance-measuring operation, and a third auto-focus operation of performing the distance-measuring operation by the distance-measuring device in an irradiation state of the auxiliary light for distance measurement to adjust the focus of the photographing lens in accordance with the result of the distance-measuring operation.

According to a sixth aspect of the present invention, there is provided a camera including a focusing apparatus, comprising:

a photographing lens;

a first auto-focus section which adjusts a focus of the photographing lens based on a contrast of a subject image obtained via the photographing lens;

a pair of optical systems which are different from the photographing lens;

a second auto-focus section which adjusts the focus of the photographing lens based on a pair of subject images obtained via the pair of optical systems;

a flash light irradiating section which irradiates a subject with a flash light;

a judging section which judges whether or not an auto-focus operation by the first auto-focus section is appropriate; and

a control section which operates the first auto-focus section, when the judging section judges that the auto-focus operation by the first auto-focus section is appropriate and which operates both the second auto-focus section and the flash light irradiating section, when the judging section judges that the auto-focus operation by the first auto-focus section is inappropriate.

According to a seventh aspect of the present invention, there is provided a camera including a focusing apparatus, comprising:

a photographing lens;

an image pickup device which acquires an image signal of a subject in a photographing field via the photographing lens at the time of photographing;

an optical system which is different from the photographing lens;

a distance-measuring section which uses the optical system different from the photographing lens to acquire a plurality of image signals and which obtains a distance of a main subject based on the acquired plurality of image signals prior to the photographing;

a projecting section which emits a light to the main subject in a case where the plurality of image signals acquired by the distance-measuring section are inappropriate for an operation of obtaining the main subject distance by the distance-measuring section; and

a control section which controls a focus of the photographing lens in accordance with the distance of the main subject obtained by the distance-measuring section with the emission of the projecting section and which determines whether or not to continuously control the focus by a contrast change of the image signal outputted from the image pickup device with a focal position movement of the photographing lens.

According to an eighth aspect of the present invention, there is provided a camera including a focusing apparatus, comprising:

a photographing lens;

an image pickup device which acquires a subject image signal via the photographing lens;

a first focusing control section which detects a contrast of the subject image signal acquired by the image pickup device to control the focusing of the photographing lens based on the detected contrast;

a projecting section which projects a light to a subject;

an optical system for distance measurement which acquires a plurality of subject image signals different from the subject image signal acquired by the image pickup device during the projection by the projecting section;

a distance-measuring section which obtains a subject distance based on the plurality of subject image signals acquired via the optical system for distance measurement;

a second focusing control section which controls the focusing of the photographing lens based on the subject distance obtained in the distance-measuring section; and

a determining section which determines whether to control the focusing by the first focusing control section or the second focusing control section in accordance with the subject distance obtained by the distance-measuring section.

According to a ninth aspect of the present invention, there is provided a camera including a focusing apparatus, comprising:

a photographing lens;

an image pickup device which acquires a subject image signal via the photographing lens;

a first auto-focus section which performs focusing of the photographing lens based on a contrast of the subject image signal acquired by the image pickup device;

a pair of optical systems which are different from the photographing lens;

a distance-measuring device which uses a pair of subject image signals obtained via the pair of optical systems to perform distance measurement;

a second auto-focus section which performs the focusing of the photographing lens in accordance with a distance measurement result of the distance-measuring device;

a flash light irradiating section which irradiates a subject with a flash light;

a judging section which judges whether or not the pair of subject image signals obtained via the pair of optical systems or the subject image signal acquired by the image pickup device is appropriate for a distance-measuring operation of the distance-measuring device; and

a control section which irradiates the subject with the flash light in accordance with a judgment result of the judging section by the flash light irradiating section and which performs the focusing of the photographing lens preferentially by the second auto-focus section.

According to a tenth aspect of the present invention, there is provided a camera including a focusing apparatus, comprising:

a flash section which irradiates a subject with an auxiliary light;

a photographing lens;

a contrast type focusing section which acquires a subject image signal at the time of displacement of the photographing lens by a micro amount via the photographing lens and which determines a focusing position in accordance with a contrast change of the acquired subject image signal to control the focusing of the photographing lens;

an optical system which is different from the photographing lens;

a distance-measuring section which acquires a plurality of subject image signals via the optical system different from the photographing lens to measure a distance of the subject based on the acquired plurality of subject image signals; and

a control section which determines whether to continue focusing control by the contrast type focusing section or to change to the focusing control to determine the focusing position based on the distance measured by the distance-measuring section, based on the plurality of subject image signals acquired by the distance-measuring section when the subject is irradiated with the auxiliary light by the flash section.

According to an eleventh aspect of the present invention, there is provided a camera including a focusing apparatus, comprising:

a photographing lens;

a driving mechanism which drives the photographing lens along an optical axis direction;

an image pickup device which receives a subject light flux incident via the photographing lens to output the subject image signal;

an image processing circuit which processes the subject image signal outputted from the image pickup device;

a distance-measuring device which includes a pair of optical systems and a pair of sensors for distance measurement to detect a pair of subject images incident via the pair of optical systems and which outputs information associated with a subject distance based on the subject images detected by the sensors for distance measurement; and

a CPU which detects the subject image signal processed by the image processing circuit or a brightness distribution of the subject images detected by the sensors for distance measurement to select either one of the first and second auto-focus operations based on the detection result and which selectively executes a first auto-focus operation of detecting a contrast based on the subject image signal processed by the image processing circuit to adjust a focus of the photographing lens, and a second auto-focus operation of performing a distance-measuring operation by the distance-measuring device to adjust the focus of the photographing lens in accordance with a result of the distance-measuring operation.

According to a twelfth aspect of the present invention, there is provided a camera including a focusing apparatus, comprising:

a photographing lens including a diaphragm mechanism;

an image pickup section which includes an image pickup device to photographs a subject image incident via the photographing lens to obtain a subject image signal;

a setting section which sets conditions of an image pickup operation by the image pickup section;

a first auto-focus section which focuses the photographing lens from a contrast of the subject image signal obtained by the image pickup section;

a pair of optical systems for distance measurement which are different from the photographing lens;

a distance-measuring section which includes a pair of sensors for distance measurement to acquire a pair of subject image signals via the pair of optical systems for distance measurement and which performs a distance-measuring operation to calculate a subject distance from the pair of subject image signals;

a second auto-focus section which focuses the photographing lens based on the distance measurement result of the distance-measuring section;

a selecting section which detects the subject image signal obtained by the image pickup device or a brightness distribution of the pair of subject image signals obtained by the sensors for distance measurement to select either one of the first and second auto-focus sections in accordance with a ratio of a low-brightness portion in the detected brightness distribution; and

a change section which changes the conditions of the distance-measuring operation set by the setting section, when the selecting section selects the second auto-focus section.

According to a thirteenth aspect of the present invention, there is provided a camera including a focusing apparatus, comprising:

a photographing lens;

a first auto-focus section which includes an image pickup device to obtain a contrast of a subject image signal obtained via the photographing lens and which adjusts a focus of the photographing lens based on the contrast of the subject image signal obtained by the image pickup device;

a pair of optical systems which are different from the photographing lens;

a second auto-focus section which includes a distance-measuring device to perform a distance-measuring operation based on a pair of subject image signals obtained via the pair of optical systems and which adjusts the focus of the photographing lens in accordance with the output of the distance-measuring device;

a detecting section which detects the subject image signal obtained by the image pickup device or a brightness distribution of the pair of subject image signals obtained by the distance-measuring device; and

a change section which selects the second auto-focus section in accordance with a ratio of a low-brightness portion of a brightness distribution detected by the detecting section and which changes an aperture value of the diaphragm mechanism in the photographing lens and a sensitivity of the image pickup device.

According to a fourteenth aspect of the present invention, there is provided a camera including a focusing apparatus, comprising:

a photographing lens;

an optical system which is different from the photographing lens;

a distance-measuring section which acquires a plurality of subject image signals via the optical system different from the photographing lens prior to a photographing operation to obtain a distance of a main subject based on the acquired plurality of subject image signals; and

a judging section to judge a scene in which sensitized photographing is possible by a brightness change in the plurality of subject image signals acquired by the distance-measuring section, the judging section controlling focusing of the photographing lens in accordance with the distance of the main subject obtained by the distance-measuring section and changing the diaphragm of the photographing lens and a sensitization sensitivity at the time of the photographing, when judging the scene in which the sensitized photographing is possible.

According to a fifteenth aspect of the present invention, there is provided a camera including a focusing apparatus, comprising:

a photographing lens including a zoom optical system;

an image pickup section which photographs a subject via the zoom optical system to obtain a subject image signal;

an optical system which is different from the photographing lens;

a distance-measuring section which acquires a plurality of subject image signals via the optical system different from the photographing lens to measure a subject distance based on the acquired plurality of subject image signals;

a first focusing control section which determines a focusing position of the photographing lens based on an output of the distance-measuring section;

a second focusing control section which determines the focusing position of the photographing lens based on a contrast change of the subject image signal acquired by the image pickup section, when the photographing lens is slightly driven;

a zoom position detecting section which detects the position of the zoom optical system; and

a selecting section which selects either one of the first and second focusing control sections in accordance with the position of the zoom optical system detected by the zoom position detecting section and a brightness change of the subject image signal acquired by the image pickup section.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1A is a block diagram showing a schematic constitution of an electric system of a focusing apparatus according to a first embodiment of the present invention;

FIG. 1B is an appearance perspective view of a camera to which the focusing apparatus is applied in the first embodiment of the present invention;

FIG. 2 is a diagram showing an example of a scene in which a general digital camera (electronic camera) is weak in focusing;

FIG. 3 is a flowchart showing a focusing operation of the general digital camera;

FIG. 4 is a diagram showing an example of a lens position and contrast change for each point in the scene of FIG. 2;

FIG. 5 is a flowchart showing a focusing operation of the camera in the first embodiment of the present invention;

FIG. 6 is a flowchart showing another example of the focusing operation;

FIGS. 7A, 7B are explanatory views of the focusing in a scene in which distance measurement of a plurality of points is possible in a photographing field;

FIGS. 8A, 8B are diagrams showing an example of the contrast change in the scene of FIGS. 7A, 7B;

FIG. 9 is a flowchart showing the focusing operation of the camera in a second embodiment of the present invention;

FIGS. 10A, 10B are explanatory views of focusing control in the second embodiment;

FIG. 11 is a block diagram showing the schematic constitution of the electric system of the camera including the focusing apparatus in a third embodiment of the present invention;

FIG. 12A is an explanatory view of a positional relation of an optical system of the camera in the third embodiment;

FIG. 12B is an appearance constitution diagram of the camera in the third embodiment;

FIG. 12C is a diagram showing an example of a photographing scene in a case where a main subject exists in a part other than a middle part in the photographing field;

FIGS. 13A to 13F are diagrams showing various photographing scenes and subject image signals obtained at this time;

FIG. 14 is a flowchart at the time of photographing control of the camera in the third embodiment of the present invention;

FIG. 15 is a timing chart at the time of the photographing control of the camera in the third embodiment of the present invention;

FIG. 16A is an explanatory view of a distance measurement principle by a distance-measuring device of a external metering system;

FIG. 16B is a diagram showing a distance measurement point in a multipoint distance-measuring device;

FIG. 17 is a flowchart of contrast judgment;

FIG. 18 is a distribution diagram of a subject distance;

FIG. 19 is a flowchart at the time of the photographing control of the camera in a fourth embodiment of the present invention;

FIG. 20 is a flowchart of the photographing control in a case in which an image pickup device is used to detect a contrast;

FIG. 21 is a block diagram showing a schematic constitution of the electric system of the camera including the focusing apparatus in a fifth embodiment of the present invention;

FIG. 22 is a diagram showing an example of a photographing scene in a case in which the main subject exists in a part other than the middle part in the photographing field;

FIGS. 23A to 23D are diagrams showing various photographing scenes and subject image signals obtained at this time;

FIG. 24 is a flowchart at the time of the photographing control of the camera in the fifth embodiment of the present invention;

FIG. 25 is a timing chart at the time of the photographing control of the camera in the fifth embodiment of the present invention;

FIG. 26 is a flowchart at the time of the photographing control of the camera in a sixth embodiment of the present invention;

FIG. 27A is a graph showing output characteristics of the image pickup device;

FIG. 27B is a distribution diagram showing one example of the subject image signal;

FIG. 28A is a graph showing the output characteristics of the image pickup device;

FIG. 28B is a distribution diagram showing the subject image signal in a case in which an image signal having a level larger than a noise level is subjected to sensitization process;

FIG. 29A is a graph showing the output characteristics of the image pickup device;

FIG. 29B is a distribution diagram showing the subject image signal in a case in which the image signal having a level not more than the noise level is subjected to the sensitization process; and

FIG. 30 is an explanatory view of a relation between a diaphragm and blur amount.

### DETAILED DESCRIPTION OF THE INVENTION

Embodiments of the present invention will hereinafter be described with reference to the accompanying drawings.

[First Embodiment]

FIG. 2 is a diagram showing an example of a scene in which a general digital camera (electronic camera) is weak in focusing.

That is, in a photographing field 1, a middle part has a bright background 2b and has a high contrast. An essential main subject 2a is dark slightly against light, and also has a relatively low contrast. In this scene, the background 2b which is high contrast is easily focused. The present invention provides a measure for this scene.

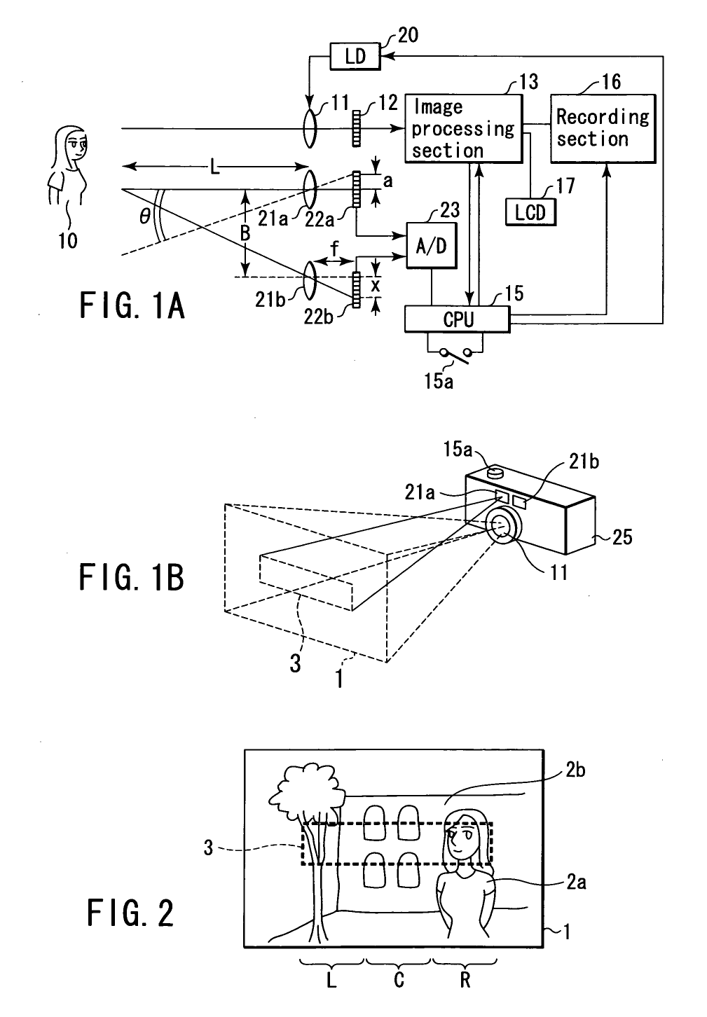

FIG. 1A is a block diagram showing a schematic constitution of an electric system of a camera to which a lens focusing apparatus is applied according to a first embodiment of the present invention.

In FIG. 1A, a photographing light flux from a main subject 10 reaches an image pickup device 12 via a photographing lens 11. Moreover, a signal of an image converted to an electric signal by the image pickup device 12 (subject image signal) is outputted to a recording section 16 and a monitor liquid crystal (LCD) 17 for display from an image processing section 13 which processes the image by control of a control section (CPU) 15. Moreover, the control section 15 moves the photographing lens 11 via a lens driver (LD) 20.

Furthermore, the photographing light flux from the main subject 10 is incident upon a pair of sensor arrays 22a, 22b for external metering AF via a pair of light receiving lenses 21a, 21b. The images obtained by these sensor arrays 22a, 22b are converted to electric signals here. Thereafter, the signals are outputted to the CPU 15 via an A/D converting section 23. Here, a switch denoted with a reference numeral 15a is a release switch.

Now, the image of the main subject 10 is formed on the image pickup device 12 via the photographing lens 11. The focus of the photographing lens 11 is controlled by the CPU 15 via the lens driver 20 constituted of an actuator. Moreover, the image of the subject 10 obtained via the photographing lens 11 is formed on the image pickup device 12. The image obtained by the image pickup device 12 is converted to the electric signal, and subjected to processing such as gamma conversion and edge emphasis by the image processing section 13. Thereafter, the signal is compressed and recorded in the recording section 16, or displayed in the LCD 17.

These controls are performed, when an operation of the release switch 15a by a user is detected by the CPU 15. Here, in the first embodiment, in the focusing control of the photographing lens 11, a distance-measuring device of a so-called external metering passive system is subsidiarily used. The device is constituted of the pair of light receiving lenses 21a, 21b, the pair of sensor arrays 22a, 22b disposed opposite to the light receiving lenses, and the A/D converting section 23.

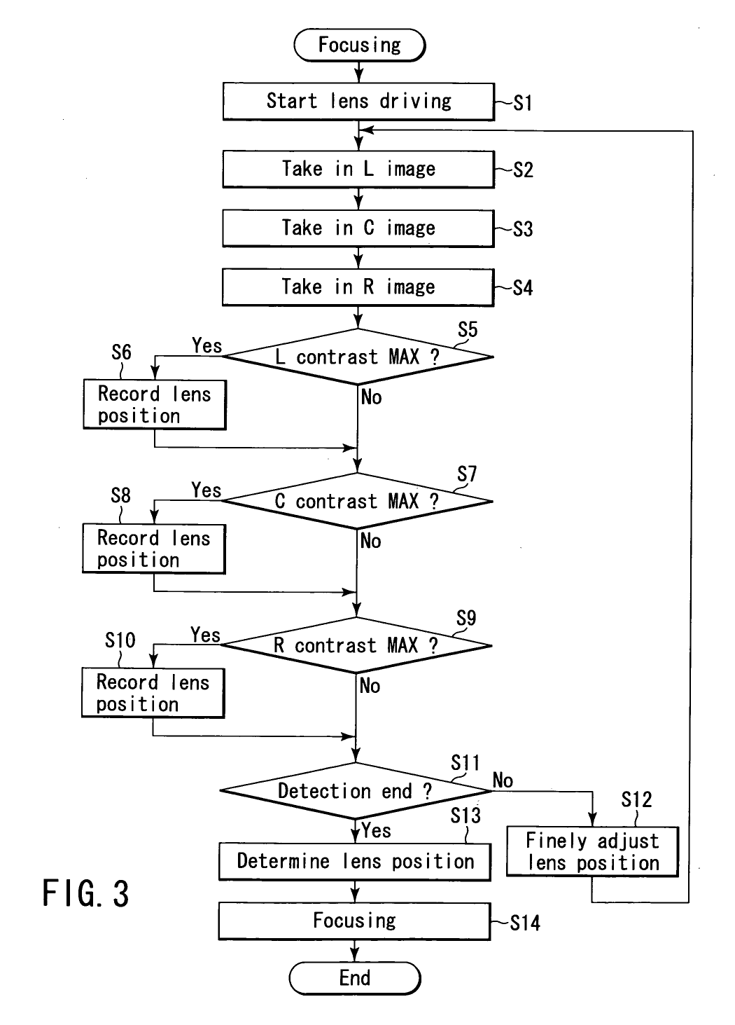

In general, for the digital camera, since a position error at the time of control of the photographing lens 11 cannot be canceled, the output of the distance-measuring device of the external metering system is not used as such. That is, final judgment is not performed by the contrast of the subject image signal on the image pickup device 12, and micro focus deviation remains in many cases. Then, to perform correct focusing in the scene shown in FIG. 2, a sequence shown in a flowchart of FIG. 3 needs to be used.

That is, the photographing lens 11 is controlled in step S1. In steps S2 to S4, images of points (L, C, R) in a photographing field 1 shown in FIG. 2 are taken in. Moreover, a lens position where the contrast of the taken subject image signal is maximized is obtained for each point of L, C, R in the subsequent steps S5 and S6, S7 and S8, and S9 and S10.

After obtaining the maximum contrast position of all the points (L, C, R), it is judged in step S11 whether or not detection ends. When the detection does not end here, the flow shifts to step S12 to finely adjust the lens position. Thereafter, the flow shifts to the step S2 to repeat the subsequent process.

On the other hand, when the detection ends in the step S11, the lens position is not finely adjusted thereafter, and in step S13, the lens position most suitable for the focusing is determined from the lens positions obtained in the steps S6, S8, S10. Thereafter, the focusing is performed again in step S14.

When such time-consuming control is performed, a brightness difference between the points has to further be considered.

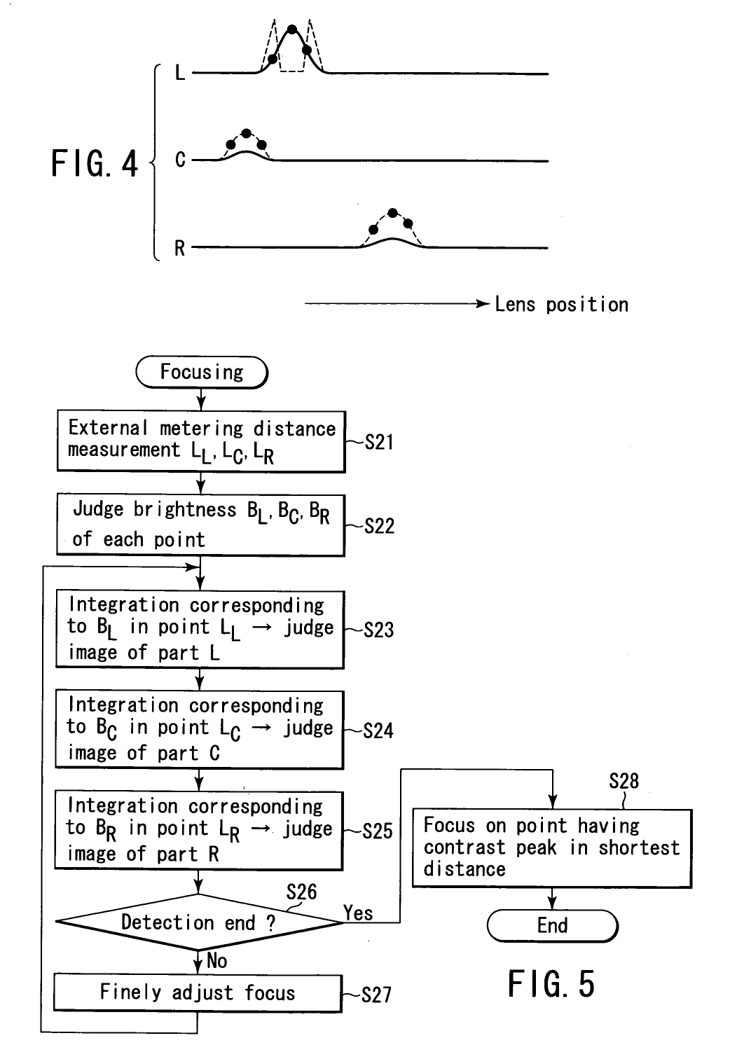

As shown in FIG. 4, the lens position is shown along the abscissa, and the contrast change is shown along the ordinate. Then, unless an accumulation time of pixels at the time of the detection of the image is appropriate, as shown by a solid line, a correct peak is obtained in the point of L, but the contrast is not obtained in the point of R in some case. Moreover, as shown by a broken line in the drawing, when a correct contrast change is obtained in R, the image is saturated in L and the focal position cannot be detected in some case.

In this manner, unless the correct image detection (accumulation time of the image pickup device) is selected for each point, as shown in FIG. 2, the correct focusing cannot be performed with respect to a scene in which a brightness difference is large and the main subject 2a does not exist in the middle of the photographing field 1.

To solve the problem, in the first embodiment, the above-described sensor array is used to monitor an area 3 of the photographing field 1 shown in FIG. 2. Accordingly, the position of the main subject existing in the photographing field 1 is judged, and accumulation control to be performed by the image pickup device can correctly be determined.

FIG. 1B is a diagram showing a relation of the appearance to which the lens focusing apparatus is applied with respect to the monitor area 3 of the sensor array and the photographing field 1 in the first embodiment of the present invention.

In FIG. 1B, the release switch 15a is disposed on the upper surface of a camera 25. The photographing lens 11 and a pair of light receiving lenses 21a, 21b for AF are disposed on the front surface of the camera 25.

Next, a focusing operation of the camera in the first embodiment will be described with reference to a flowchart of FIG. 5.

First, in step S21, the CPU 15 obtains distance judgment results L_{L}, L_{C}, L_{R} Of the respective points L, C, R by the sensor arrays 22a, 22b for the external metering distance measurement which is a characteristic of the first embodiment. It is to be noted that three points L, C, R have been described for the sake of simplicity here, but it is arbitrary to increase the number of points.

Here, it is assumed as shown in FIG. 1A that a distance between two light receiving lenses 21a, 21b is a base length B, and a focal distance of the light receiving lenses 21a, 21b is f. When a positional difference of the images of the main subject 10 formed on the sensor arrays 22a, 22b is x, a subject distance L can be obtained from the following in accordance with a principle of triangular distance measurement:

L=B·f/x.

Moreover, when using image data of point a having a relation of a=f tanθ with respect to the main subject 10 deviating from the optical axis by 0, the distance measurement can be carried out in a similar way of thinking.

Furthermore, since image data change of each point is known by the sensor for distance measurement, the CPU 15 uses this image data change to obtain brightness information B_{L}, B_{C}, B_{R} in step S22.

That is, the point which is to be subjected to contrast judgment and a charge accumulation control by which the contrast is judged are known by the relation. Therefore, in the subsequent steps S23 to S25, the CPU 15 executes the charge accumulation (integration) control in accordance with the brightness of each point while judging the image on the image pickup device to detect the contrast. Accordingly, the contrast judgment optimum for each point is carried out.

Thereafter, in step S26 the CPU 15 judges whether or not the detection has ended. When the detection does not end, the flow shifts to step S27 to finely adjust the focus. Thereafter, the flow shifts to the step S23 to repeat the subsequent process.

On the other hand, when the detection ends in the step S26, the flow shifts to step S28. The CPU 15 obtains a contrast peak position of each point, and focuses the photographing lens 11 with respect to a position having a peak of contrast in a shortest distance.

At this time, the distance result of each point by the distance-measuring device is used to first judge the contrast of the point indicating a longest distance. Next, the lens is fed forwards to judge the contrast of the next point. Then, the lens is controlled only in the points shown by black circles in FIG. 4, and the focus can be detected in a feedback system at high rate and precision without any waste.

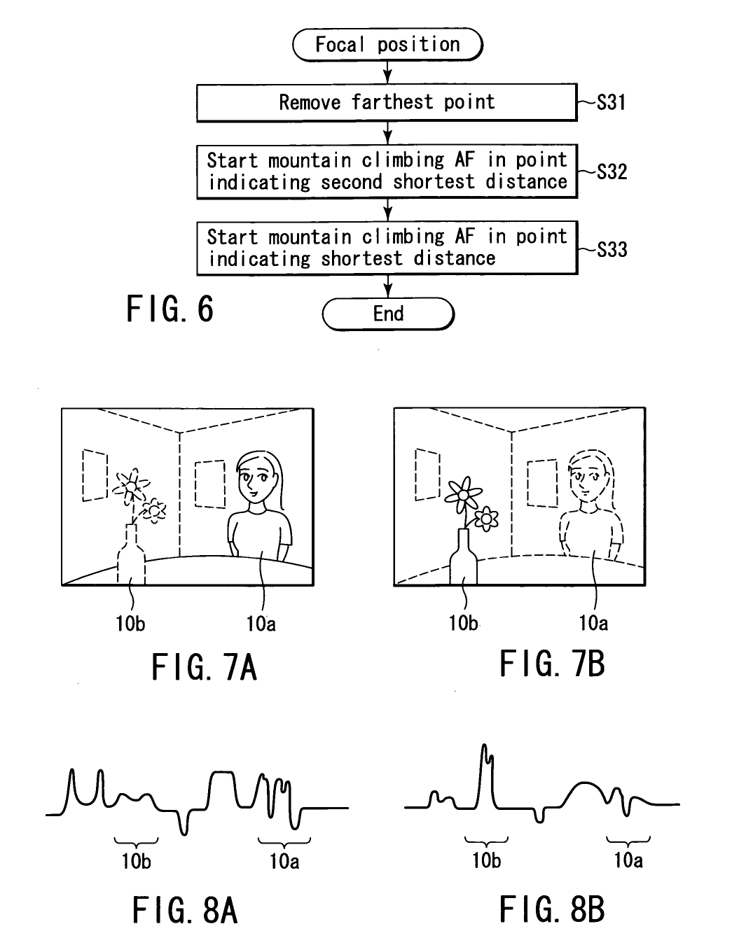

Moreover, the focusing can be carried out following a sequence shown in a flowchart of FIG. 6.

That is, with the use of the way of thinking in which the point having the shortest distance is assumed to be the main subject, the focal position may also be controlled excluding a farthest point. In FIG. 6, the CPU 15 removes the farthest point in step S31, and performs the mountain climbing AF of the feedback system from a farther point in the remaining two points in the subsequent steps S32 and S33.

In this example, after performing the mountain climbing AF of the feedback system, the flow shifts to step S28 in the flowchart of FIG. 5. An actually nearer point can more correctly be detected from two points indicating the short distance to perform the focusing.

As described above, according to the first embodiment, the sensor array for the external metering distance measurement is effectively used not only in detecting the distance but also as the light metering device which detects the brightness. Therefore, the image at the time of the focus control can more correctly be detected.

Moreover, the distance, point, and accumulation (integration) control in detecting the contrast are judged beforehand, and the necessary point is focused. Therefore, the correct focusing is possible without any waste, in which a position control error of the lens has been canceled.

[Second Embodiment]

Next, a second embodiment of the present invention will be described. Here, since a constitution of the second embodiment is similar to that described with reference to FIG. 1, description thereof is omitted.

For example, assuming that the distance measurement of a plurality of points in the photographing field is possible in the above-described camera, in a scene shown in FIG. 7A, a flower 10b in front is sometimes focused, not a person 10a which is the main subject. In this case, as shown in FIG. 7B, there occurs a risk that the person 10a is out of focus. In the second embodiment, in order to prevent this, the contrast change in the photographing field is noted, and is effectively used.

That is, in the focused state shown in FIG. 7A, as shown in FIG. 8A, the contrast is high in the whole photographing-field. On the other hand, in the focused state shown in FIG. 7B, as shown in FIG. 8B, the contrast is high only in the part of the flower lob, and a whole photograph is out of focus. Therefore, in the second embodiment, not only the distance result by the distance-measuring device but also the whole contrast are considered in controlling the focusing.

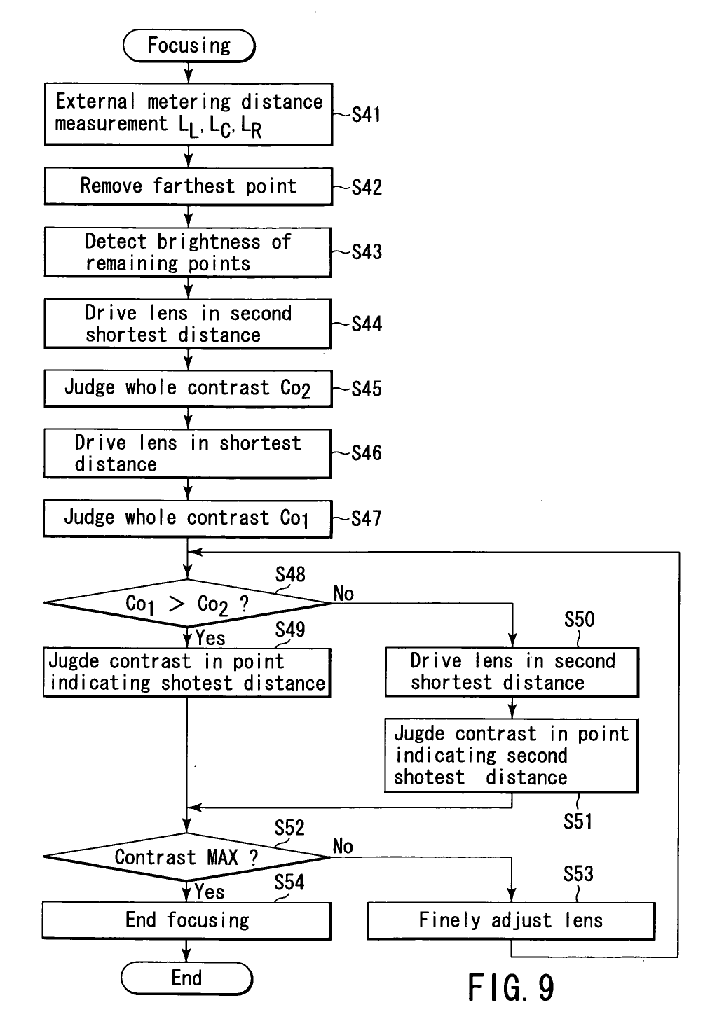

FIG. 9 is a flowchart showing the focusing operation by the second embodiment.

First, in step S41, the CPU 15 measures the distances of a plurality of points in the photographing field by the distance-measuring device of the external metering system. Next, in step S42, in the way of thinking similar to that of the flowchart of FIG. 6, the point indicating the longest distance is removed from candidates for focus detection.

In step S43, the CPU 15 detects the distribution of brightness of the remaining points by the distance-measuring device. Accordingly, the integration control of the image pickup device suitable at the time of the contrast judgment of each point is determined.

In step S44, the CPU 15 adjusts the focus of the photographing lens with respect to the results of the distance measurement of the plurality of points (three points) or the second shortest distance. Moreover, in the subsequent step S45, a contrast value obtained substantially from the whole of the image pickup device is detected as Co₂.

Next, in step S46, the CPU 15 controls the focusing (photographing) lens so as to focus on the vicinity of the shortest distance in the distances obtained in the step S41. Furthermore, in step S47, the CPU 15 judges the whole contrast again, and detects the contrast value as Co₁.

Thereafter, in step S48, the CPU 15 compares the contrast value Co₁ with Co₂ in order to perform the focusing in consideration of the whole contrast.

That is, when Co₁ is larger, the whole contrast is assumed to be also high even with the use of the subject image signal of the point indicating the shortest distance. The flow shifts to step S49 to control the focus. On the other hand, when Co₂ is larger, the contrast of the whole photographing field is assumed to be higher in the second shortest distance. Then, the flow shifts to step S50 to control the lens again, and the focusing is controlled in the point indicating the second shortest distance.

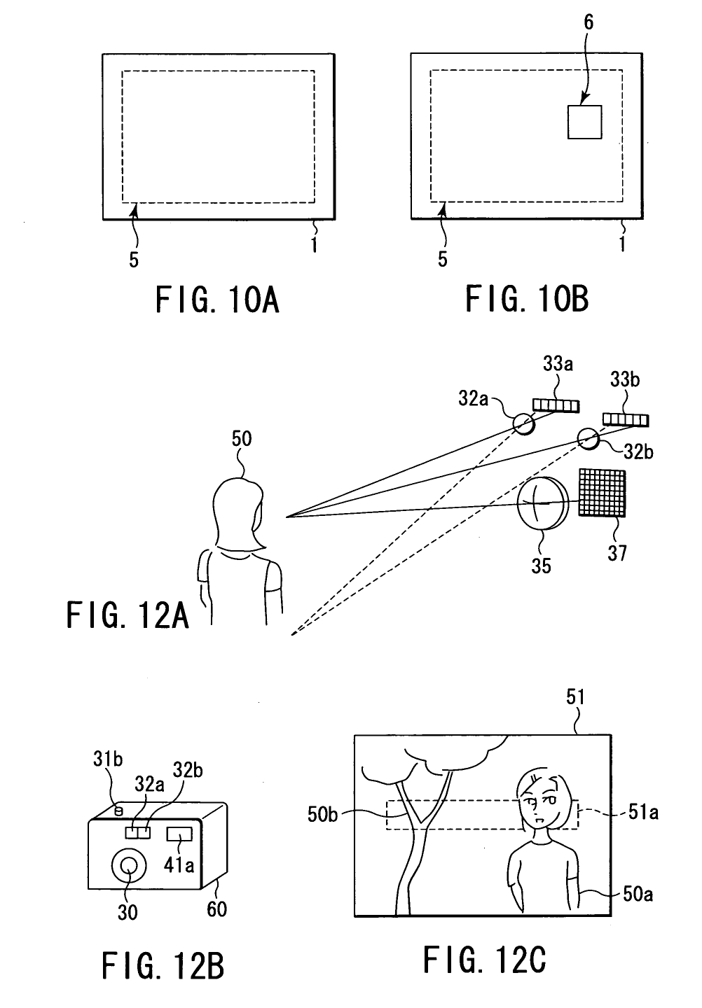

That is, the focusing is controlled by the contrast of the image of a small region 6 shown in FIG. 10B. However, when the focal position is selected in the steps S47 and S48, the contrast of the image of a large region with respect to the photographing field 1 is used as shown by a region 5 shown in FIG. 10A.

In this manner, the contrast of the image of the small region in the photographing field is used to finely adjust the lens in a point which has a maximum contrast. That is, in step S52, the CPU 15 judges whether or not the contrast of the image is maximum.

As a result, when the contrast is not maximum, the flow shifts to step S53 to finely adjust the photographing lens. Thereafter, the flow shifts to the step S48 to repeat the subsequent process. On the other hand, when the contrast is maximum, the flow shifts to step S54, and the focusing process ends.

In the scene shown in FIGS. 7A and 7B, first the focus of the whole image is judged using the region 5 of FIG. 10A in the lens position corresponding to two distances. Moreover, contrast AF by the image pickup device is performed in the image detection area 6 corresponding to the person 10a. This AF is a system in which the lens position of the photographing lens is changed while obtaining the peak of the contrast. Therefore, this is referred to as the mountain climbing AF.

As described above, according to the second embodiment, in consideration of contrast information of the image pickup device together with a distance output of the distance-measuring device, the focusing point is determined. Moreover, the image of the image pickup device area of the point is used. Therefore, the photographing without any failure such as blur can correctly be performed at a high rate.

[Third Embodiment]

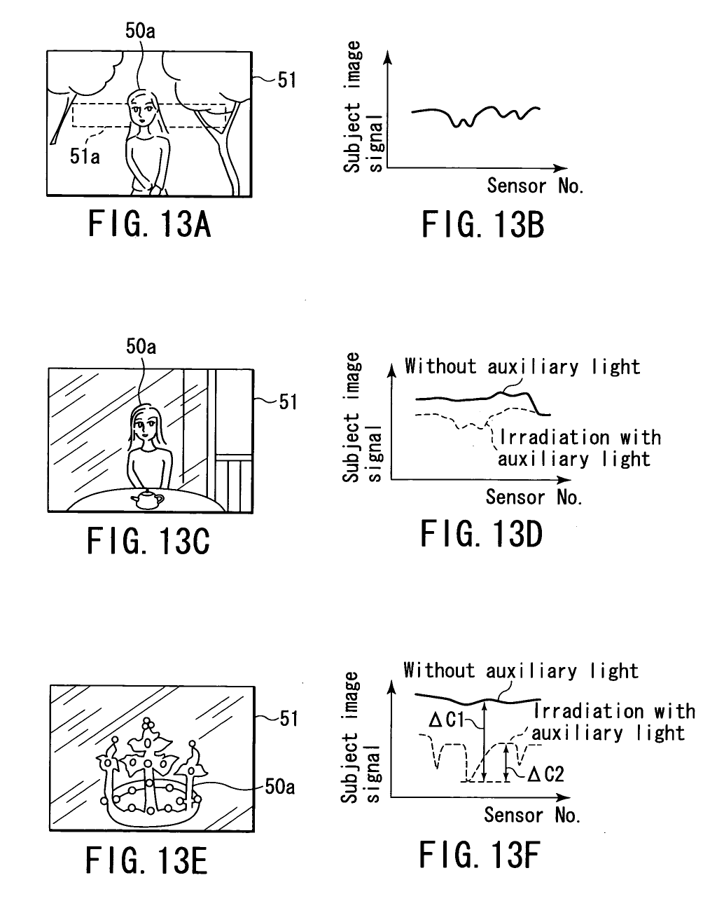

Prior to the description of a third embodiment, a function of the camera in the third embodiment of the present invention will be described with reference to FIGS. 13A to 13F.

Since the subject has a clear brightness distribution in a snap shot of a bright landscape as shown in FIG. 13A, the subject image signal high in contrast is obtained as shown in FIG. 13B. In this case, since the subject image signal is clear, the external metering AF can be carried out with high precision. Even with the use of the mountain climbing AF, the focusing is possible at a relatively high rate.

However, in a dark scene shown in FIG. 13C, the clear subject image signal is not obtained as such. In this case, only when the subject is irradiated with an auxiliary light with a light emitting diode (LED) or flash, the subject image signal having the contrast as shown in FIG. 13D is obtained. Therefore, in the scene shown in FIG. 13C, the subject is preferably irradiated with the auxiliary light and focused. However, when the subject is repeatedly irradiated with a flash light at the time of the time-consuming mountain climbing AF, the subject is felt dazzling in many cases. Moreover, energy is also remarkably consumed.

To solve the problem, in the third embodiment, in this scene, the focusing is performed in consideration of a balance between the energy for use at the time of the focusing and the correctness of the focusing. That is, when the correctness of the focusing is guaranteed to a certain degree, the focusing is performed in the external metering AF in which the focusing can be performed with one auxiliary light irradiation.

Here, for the mountain climbing AF, the photographing lens is moved while judging the contrast of the subject image signal obtained by the image pickup device to perform the focusing. Therefore, much time is required in operating and stopping the photographing lens. Moreover, since the contrast of the subject image signal is judged every stop of the photographing lens, the subject needs to be irradiated with the auxiliary light every time. Furthermore, when the contrast in the previous photographing lens position is compared/judged with that in the next photographing lens position, and when the irradiation amount of the auxiliary light largely fluctuates, the correctness of the focusing becomes insufficient, and therefore complicated control is also required for the irradiation with the auxiliary light.

That is, in a certain situation, for the mountain climbing AF using the contrast change of the subject image signal by the image pickup device, a shutter chance is sometimes missed, the correct focusing cannot be performed for a large energy consumption, and this focusing method is not preferable for the user.

On the other hand, for the external metering AF, a pair of subject image signals obtained by one auxiliary light irradiation are basically used to measure the distance of the subject even in a dark place. This is therefore effective for energy saving and for reduction of a release time lag. However, in the external metering AF, the image incident via the photographing lens is not used as in the mountain climbing AF, and therefore an open loop control is performed. Therefore, when there is a lens position error by changes of temperature and humidity and difference of posture at the time of the control of the photographing lens, the positional error cannot be canceled. That is, when even this error is canceled to perform the correct focusing, the mountain climbing AF is preferably used.

Here, when the irradiation amount of the auxiliary light is small even in the irradiation with the auxiliary light at the time of the mountain climbing AF, the consumption of the energy can be reduced. For example, when an ornamental article is photographed as shown in FIG. 13E, a large reflected light can be expected even with the irradiation with a small amount of auxiliary light, and it is therefore possible to perform the mountain climbing AF with small energy consumption. That is, in the third embodiment, when the scene shown in FIG. 13E is photographed, the subject is irradiated with the small amount of auxiliary light to perform the mountain climbing AF. To judge the scene in which the mountain climbing AF can be performed in a short time even with the small amount of light, the subject image signal or the distance obtained at the time of the external metering AF may be used. Especially when the subject image signal obtained at the time of the irradiation with the auxiliary light is used, effective judgment can be performed.

Next, a distance measurement principle by the distance-measuring device of the external metering system in the third embodiment will be described with reference to FIG. 16A.

A pair of light receiving lenses 32a and 32b are disposed apart from each other by the base length B which is a distance between principal points, and the image from a subject 50 is guided to corresponding sensor arrays 33a and 33b. At this time, the image from the subject 50 is guided into the sensor arrays 33a and 33b, respectively, using the optical axis of the light receiving lens as an original point with a relative positional difference x in accordance with the principle of the triangular distance measurement. The distance L to the subject 50 can be obtained by this relative positional difference x.

In FIG. 16A, the image on the optical axis of the light receiving lens 32a is incident upon a position x apart from the optical axis of the light receiving lens 32b on the sensor array 33b. Here, this distance-measuring device can also obtain the distance of the subject with respect to the image of the subject which is not incident upon the optical axis of the light receiving lens 32a. For example, as shown in FIG. 16A, to obtain the distance of the subject in the position which has shifted from the optical axis of the light receiving lens 32a by θ, assuming that a focal distance of the light receiving lens is f, the image formed in the position f tanθ of the sensor array may be used to detect the relative positional difference x.

When the relative positional difference x is detected in this manner, the distance L to the subject can be obtained by a principle equation of the triangular distance measurement.

In this distance-measuring device of the external metering system, a pair of light receiving lenses 32a, 32b and sensor arrays 33a, 33b are used like human eyes, the subject distance is detected by the principle of the triangular distance measurement. Moreover, the photographing lens is focused based on the detected subject distance.

Moreover, this distance-measuring device can include a plurality of distance measurement points with respect to an arrangement direction of the sensor arrays. Accordingly, distance data of the plurality of points in the photographing field shown in FIG. 16B can be obtained. The distance-measuring device in which the distance is measured with respect to the plurality of points is referred to as a multipoint distance-measuring device.

Here, when the subject is irradiated with the auxiliary light in the dark scene, the contrast of the image is emphasized to perform the distance measurement.

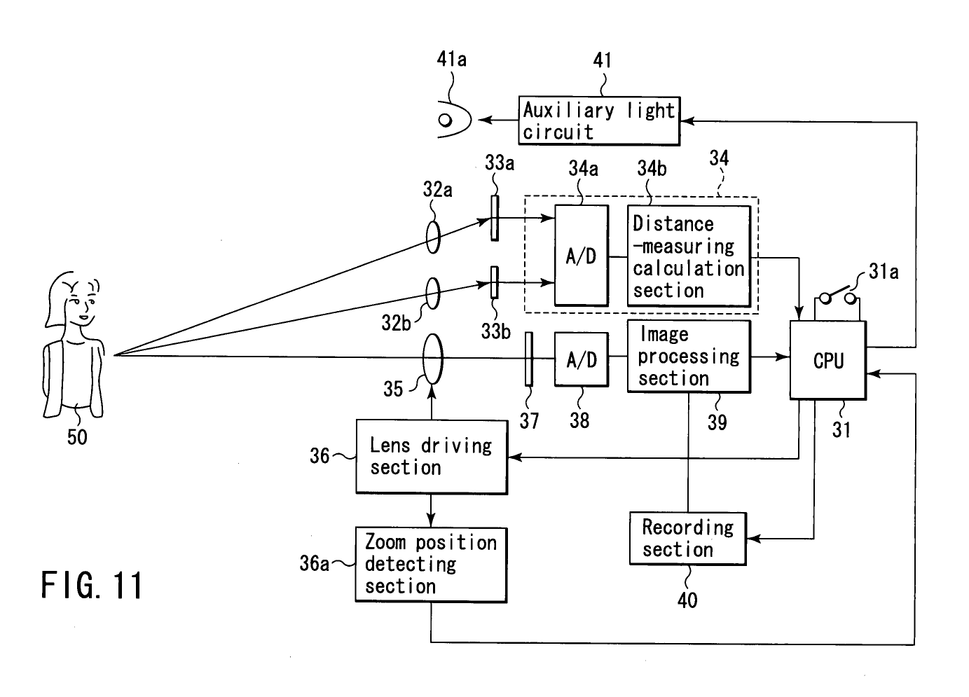

FIG. 11 is a block diagram showing the constitution of the electric system inside the camera in the third embodiment of the present invention. That is, the camera of the third embodiment of the present invention is constituted of a microprocessor (CPU) 31, the light receiving lenses 32a and 32b, the sensor arrays 33a and 33b, a distance-measuring section 34, a photographing lens 35, a lens driving (LD) section 36, an image pickup device 37, an analog/digital (A/D) converting section 38, an image processing section 39, a recording medium 40, an auxiliary light circuit 41, and a light emitting section 41a.

The CPU 31 is a calculation control section which controls the sequence of the whole camera. This CPU 31 is connected to a switch (release switch) 31a for starting the photographing sequence. The CPU 31 judges an on-operation of the release switch 31a by a user to start a series of photographing sequence.

A pair of light receiving lenses 32a and 32b receive the image from the subject 50 to form the image on a pair of sensor arrays 33a, 33b. Moreover, a pair of sensor arrays 33a and 33b convert the image from the subject 50 to an electric signal (subject image signal) to output the signal to the distance-measuring section 34.

The distance-measuring section 34 is a so-called distance-measuring device of a “passive system” constituted of an A/D converting section 34a and a distance measurement calculating section 34b. The A/D converting section 34a in the distance-measuring section 34 converts the subject image signals inputted from the sensor arrays 33a, 33b to digital signals to output the signals to the distance measurement calculating section 34b. The distance measurement calculating section 34b calculates the distance to the subject 50 from the camera, that is, the subject distance based on the digital signal in accordance with the principle of the triangular distance measurement.

Moreover, the CPU 31 controls the focusing of the photographing lens 35 based on the subject distance calculated as described above. That is, the CPU 31 controls the LD section 36 to focus the photographing lens 35 based on the subject distance calculated by the distance measurement calculating section 34b.

After ending the focusing of the photographing lens 35, an exposure operation is performed. The image pickup device 37 is constituted of CCD, and the image from the subject 50 formed via the photographing lens 35 is converted to an electric subject image signal to output the signal to the A/D converting section 38.

After converting the subject image signal to the digital signal, the A/D converting section 38 outputs the signal to the image processing section 39. After correct color or gradation of the image based on the inputted digital signal, the image processing section 39 compresses the image signal and records the image in the recording medium 40 to complete an exposure operation.

The light emitting section 41a projects the auxiliary lights for the exposure and for the distance measurement toward the subject 50 in accordance with the photographing scene. The auxiliary light circuit 41 controls emission of the light emitting section 41a.

Here, with a zoom lens type camera including a zoom lens in a photographing lens system, in addition to the above-described constitution, a zoom position detecting section 36a for detecting the position of the zoom lens is disposed in the camera.

Moreover, the positional relation between the light receiving lenses 32a, 32b and the sensor arrays 33a, 33b, and that between the photographing lens 35 and image pickup device 37 are shown in FIG. 12A. That is, the sensor arrays 33a and 33b and the image pickup device 37 can detect the image of the same subject 50. When the outputs of the sensor arrays 33a and 33b are used in calculating the subject distance, instead of the image of the subject 50 formed in the position shown by a solid line of FIG. 12A, for example, the image of the subject formed in the position shown by a broken line of FIG. 12A is used. Accordingly, as shown in FIG. 16B, it is possible to detect the distance of the subject other than the subject 50 in the photographing field.

FIG. 12B shows an appearance diagram of the camera in the third embodiment. That is, a release button 31b for operating the switch 31a is disposed on the upper surface of the camera 40. The photographing lens 35 and light receiving lenses 32a, 32b are disposed on the front surface of the camera 40 in the positional relation shown in FIG. 12A. The light emitting section 41a is disposed on the front surface of the camera 40.

Here, in the mountain climbing AF, while the position of the photographing lens 35 is changed by the LD section 36, the contrast of the image of the subject formed on the image pickup device 37 is detected. In this AF system, the position of the photographing lens 35 whose contrast is highest is judged to obtain the position as the focal position.

That is, the mountain climbing AF is a focusing control based on the principle different from that for determining the focal position based on the subject distance as in the external metering AF.

Even when the error is generated in the position control of the photographing lens 35 in this mountain climbing AF, and when the error is small, the focal position can be detected in consideration of the error. However, when a person 50a exists in a part other than a middle part in a photographing field 51 as shown in FIG. 12C, it is difficult to quickly focus the photographing lens 35 on the person 50a. That is, to specify the main subject, the contrast is judged as described above with respect to the person 50a and a tree 50b which is a background subject, and it is necessary to judge the subject that is suitable as the main subject. At this time, a process of temporarily taking in the images corresponding to the subjects in the focal position to judge the contrast is required, and much time is therefore required. Moreover, at the time of the irradiation with the auxiliary light, the light emitting section 41a needs to emit the light every contrast judgment as described above, an energy for emitting the flash light does not remain at the time of the exposure in some case.

On the other hand, in the external metering AF, the subject image signals from the sensor arrays 33a and 33b shown in FIG. 12A are detected, and a deviation of the parallax error based on a parallax error of the light receiving lenses 32a, 32b is detected to determine the subject distance. That is, the photographing lens 35 is driven only after the focal position is determined. Therefore, a time required for the focusing is shorter than that in the mountain climbing AF. The distance of the subject other than the main subject may also be determined only by switching the subject image signal for use in calculating the subject distance. Therefore, it is possible to detect the distance distribution of the subject in a broad region regardless of the position of the main subject as in a region 33c shown in FIG. 16B. Moreover, the auxiliary light may be emitted once, and this is also preferable for the energy saving.

FIG. 18 shows an example of the distance distribution obtained as described above. When the distance distribution is obtained, it is possible to detect the position of the main subject at the high rate.

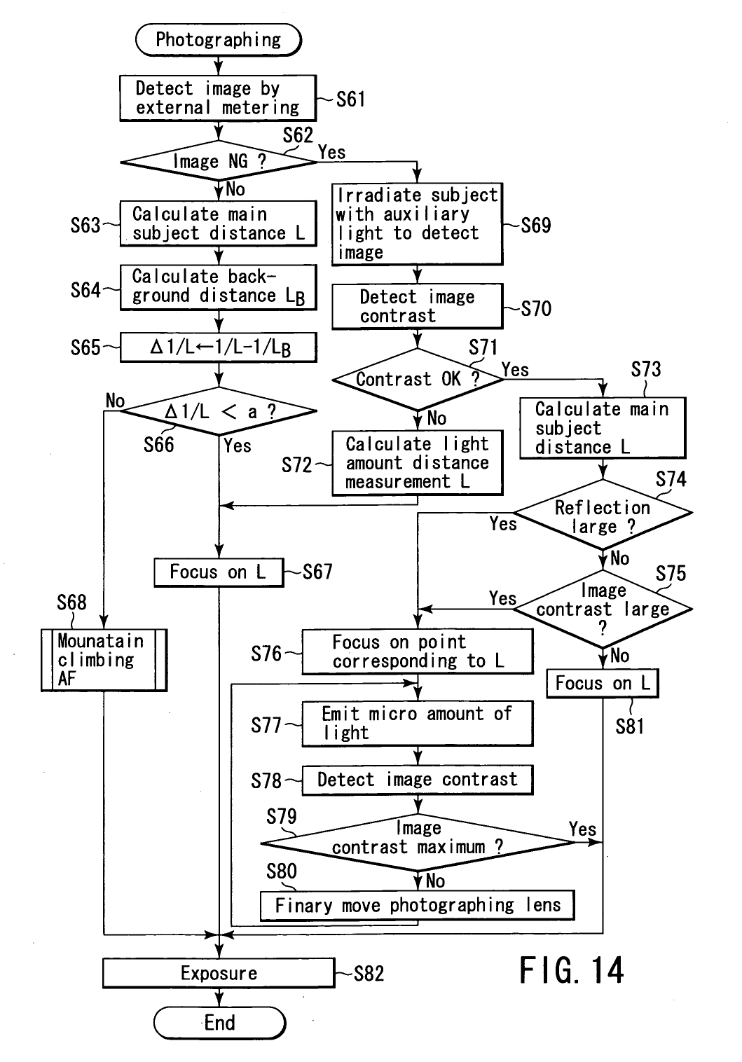

Next, the photographing control of the camera in the third embodiment will be described with reference to FIG. 14.

When the switch 31a is turned on to bring the camera into a photographing state, in step S61, the CPU 31 detects the image (subject image signal) of the subject by the external metering system. That is, the subject image signals received via the light receiving lenses 32a and 32b are detected by the sensor arrays 33a and 33b. Next, in step S62, the CPU 31 judges whether or not the detected subject image signal is unsuitable for the distance measurement.

In the judgment of the step S62, it is judged that the subject image signals detected by the sensor arrays 33a and 33b are suitable for the distance measurement as shown in FIG. 13B. In this case, the CPU 31 performs multipoint distance measurement in step S63, S64 to obtain the main subject distance L and background subject distance L_{B} from the principle equation of the triangular distance measurement. Next, in step S65, the CPU 31 obtains a difference Δ1/L between an inverse number of the main subject distance L and that of the background subject distance L_{B}. Moreover, in step S66, it is judged whether or not Δ1/L is less than a predetermined value a.

It is judged in the judgment of step S66 that Δ1/L is less than the predetermined value a. In this case, the CPU 31 focuses the photographing lens 35 on the main subject distance L in step S67. That is, in this case, since the distance between the main subject and the background is short, the photographing lens 35 is focused in this short distance, and then a photograph satisfactory for the user can be obtained without exactly focusing only on the main subject. In this case, the release time lag is preferentially reduced, and the focusing is performed in the external metering AF without performing the mountain climbing AF. After focusing the photographing lens 35 in this manner, the flow shifts to step S82.

On the other hand, it is judged in the judgment of the step S66 that Δ1/L is not less than the predetermined value a. In this case, after performing the mountain climbing AF in step S68, the CPU 31 shifts to step S82. That is, in this case, the image of the background needs to be separated from that of the person. When the focusing is performed without correctly separating the image of the background from that of the person, there is a possibility that either the main subject or the background is not focused. To solve the problem, when Δ1/L is judged to be not less than the predetermined value a, the mountain climbing AF is performed to give priority to focus precision.

Here, when the mountain climbing AF is performed, the data of the image of the main subject selected in the external metering AF is used. That is, first the main subject distance L is obtained from the result of the external metering AF, the position of the photographing lens 35 is adjusted to the focal position corresponding to this L, and the contrast by the mountain climbing AF is detected. Accordingly, the mountain climbing AF is speeded up.

Next, when the subject image signals detected in the sensor arrays 33a and 33b are judged not to be suitable for the distance measurement in the judgment of the step S62, the CPU 31 irradiates the subject with the auxiliary light to detect the subject image signal in step S69. Here, at this time, the auxiliary light for the irradiation may also be a light from LED in addition to the flash light. Any flash light for exposure control can be used instead. Therefore, a new light source for the auxiliary light irradiation is not required, cost can be reduced, and space can be saved, but much energy is required at the time of the emission. On the other hand, for the LED, the energy can be saved, but the contrast can also be imparted to a low-contrast subject, and there is a demerit in the cost and space.

After detecting the subject image signal in the step S69, the CPU 31 detects the contrast of the detected subject image signal in step S70. Next in step S71, the CPU 31 judges whether or not the detected contrast is suitable for the focusing, that is, whether or not the contrast of the subject image signal is larger than a predetermined level.

When the contrast is judged to be not more than a predetermined level in the judgment of the step S71, the CPU 31 obtains the main subject distance L based on an amount of reflected light (ΔC₁ of FIG. 13F) from the subject by the irradiation with the auxiliary light in step S72. Moreover, the flow shifts to step S67 to focus the photographing lens 35 on the main subject distance L. Here, this method is effective for a subject in a long distance or a subject having a low contrast. That is, in this method, the focusing is performed based on a simple principle in which the amount of the reflected light is reduced in the subject in the long distance and the amount of the reflected light increases in the subject in the short distance. Here, this distance measurement method is referred to as “light amount distance measurement” in FIG. 14.

On the other hand, when the contrast is judged to be larger than the predetermined level in the judgment of the step S71, the CPU 31 obtains the main subject distance L from the principle equation of the triangular distance measurement in step S73. Next in step S74, it is judged whether or not the amount of the reflected light is large, that is, whether or not the amount of the reflected light is larger than the predetermined value. Furthermore, it is judged in step S75 whether or not the contrast of the subject image signal is large, that is, whether or not the contrast of the subject image signal is larger than the predetermined level.

When the amount of reflected light is judged to be larger than the predetermined value or the contrast of the subject image signal is judged to be larger than the predetermined level in the judgment of the steps S74, S75, the mountain climbing AF is judged to be executable in the scene even with the irradiation with a micro amount of auxiliary light even in the subject in the short distance or in the subject shown in FIG. 13E. Then, the mountain climbing AF is performed with the small amount of auxiliary light. Then, in step S76, the CPU 31 focuses the position of the photographing lens 35 onto the focal position corresponding to the main subject distance L obtained in the step S73. Next, in step S77, a micro amount of auxiliary light is emitted toward the subject, and the contrast is detected in step S78. Moreover, in step S79, the CPU 31 judges whether or not the detected contrast is maximum. When the detected contrast is judged to be maximum, the position of the photographing lens 35 is determined as the focal position and the flow shifts to the step S82. In this case, the subject image signal is clear, the amount of auxiliary light is also sufficient, and therefore the focusing correctly ends in a short time.

On the other hand, when the detected contrast is judged not to be maximum in the judgment of the step S79, the CPU 31 moves the photographing lens 35 by a micro amount (step S80), thereafter returns to the step S77, and continues the mountain climbing AF.

Moreover, in the judgment of the steps S74, S75, it is judged that the amount of the reflected light is not more than the predetermined value and that the contrast of the subject image signal is also not more than the predetermined level. In this case, in step S81, the photographing lens 35 is focused on the main subject distance L obtained in the step S73, and the flow shifts to the step S82. That is, even when the mountain climbing AF is performed in this scene, correct focusing cannot be expected, and the energy consumption is also large. Therefore, here, the positional error of the photographing lens 35 is ignored, and the focusing by the external metering AF is performed while the energy saving is regarded as important.

After ending the focusing of the photographing lens 35 as described above, the CPU 31 performs the exposure operation to record the photographed image in step S82.

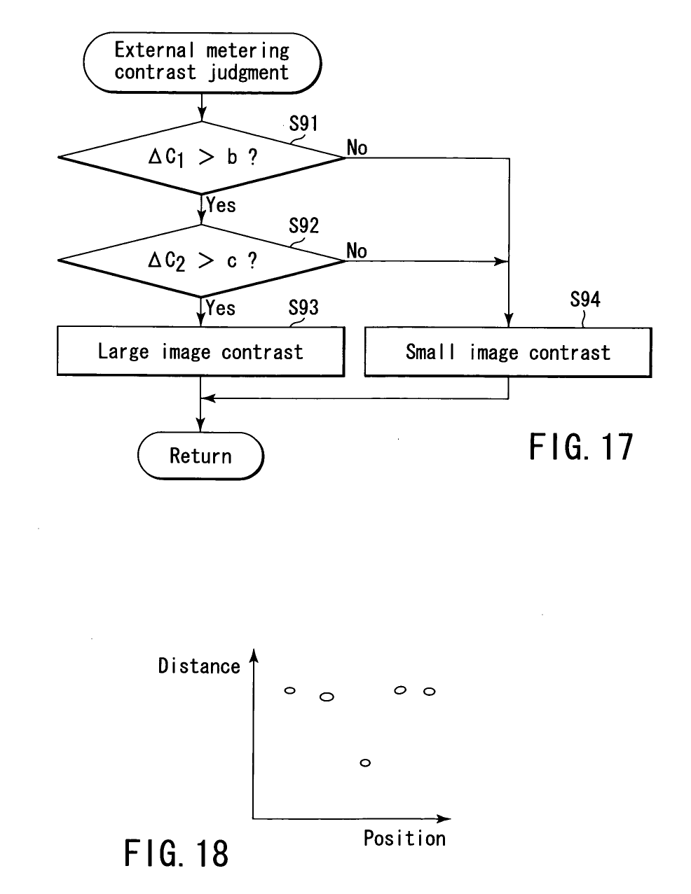

Next, the judgment of the contrast in the step S75 of FIG. 14 will be described in more detail with reference to FIG. 17.

In FIG. 17, it is assumed that a difference between the data of the image at the time when there is not the auxiliary light irradiation in FIG. 13F and the data of the image at the time of the auxiliary light irradiation is ΔC₁, and an amplitude of the image at the time of the auxiliary light irradiation is ΔC₂. In the contrast judgment, the CPU 31 first judges whether or not ΔC₁ is larger than a predetermined value b in step S91. When ΔC₁ is judged to be larger than the predetermined value b in this judgment, the CPU 31 judges in step S92 whether or not ΔC₂ is larger than a predetermined value c. When ΔC₂ is judged to be larger than the predetermined value c in this judgment, the CPU 31 judges that the contrast of the subject image signal is large in step S93, and comes out of the flowchart of this contrast judgment.

On the other hand, when in the judgment of step S91 or S92, ΔC₁ is judged to be not more than the predetermined value b or ΔC₂ is judged to be not more than the predetermined value c, the CPU 31 judges that the contrast of the subject image signal is small in step S94, and comes out of the flowchart of the contrast judgment.

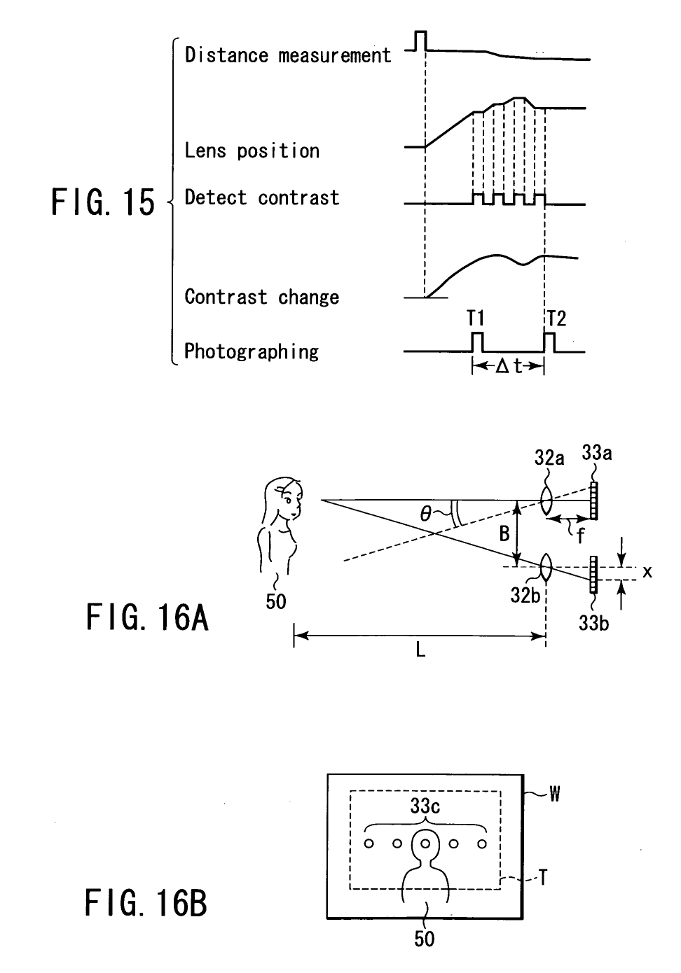

FIG. 15 shows a timing chart at the time of the photographing control in the third embodiment. At the time of the start of the photographing, first the distance measurement is performed by the external metering AF, and thereafter the photographing lens 35 is driven to adjust the focus in accordance with the result of the external metering AF. Next, the contrast is repeatedly detected in order to perform the mountain climbing AF, and the exposure is performed in the position of the photographing lens 35 where the contrast is maximized. Here, FIG. 15 also shows the signal indicating the contrast change obtained at this time.

As described above, according to the third embodiment, only when there is an effect by the auxiliary light irradiation, the mountain climbing AF including the auxiliary light irradiation is performed. Therefore, without wasting the energy, the focusing can appropriately be performed. Moreover, when the mountain climbing AF is not performed, the exposure operation is performed at a timing T₁ of FIG. 15. That is, in this case, the exposure operation is performed in a time which is shorter than a timing T₂ of the exposure operation at the time of the performing of the mountain climbing AF by Δt. Accordingly, it is possible to remarkably improve a situation in which the user is dissatisfied with an insufficient focused state of the photograph despite of much time taken in the photographing or with consumption of battery.

[Fourth Embodiment]

A fourth embodiment of the present invention will next be described. In the fourth embodiment, the constitution is similar to that of the third embodiment, but a control procedure at the time of the photographing differs.

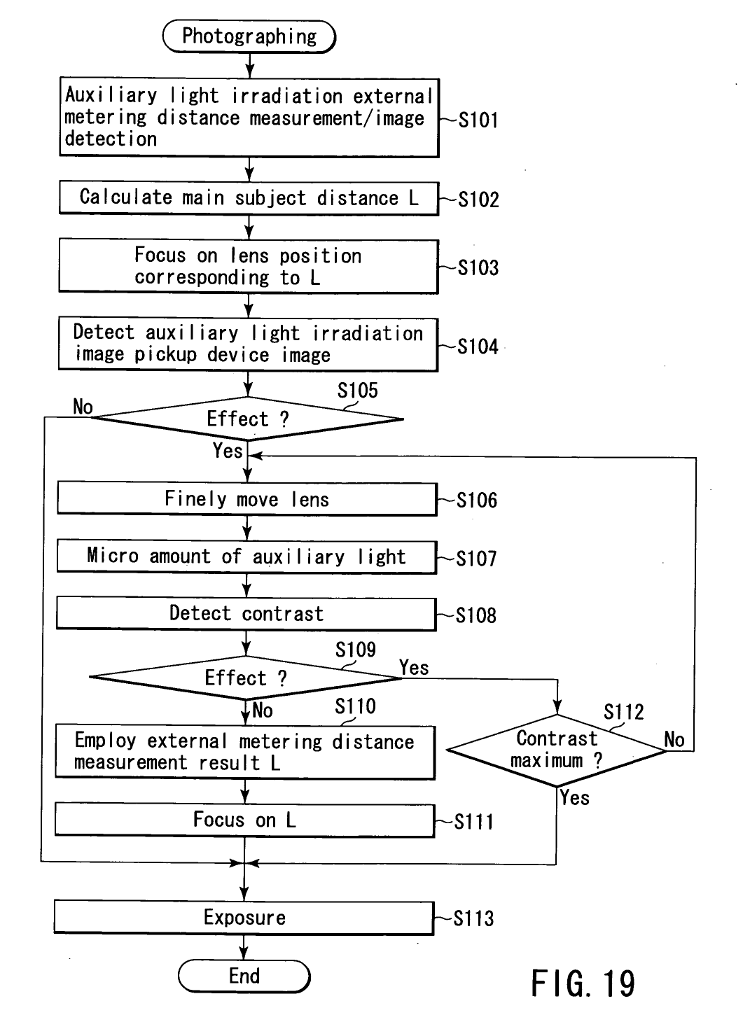

FIG. 19 is a flowchart at the time of the photographing control of the camera in the fourth embodiment. First, in step S101, the CPU 31 irradiates the subject with the auxiliary light to detect the subject image signal by the external metering system. Moreover, in step S102, the CPU 31 calculates the main subject distance L from the detected subject image signal. Next in step S103, the CPU 31 focuses the photographing lens 35 on the position corresponding to the calculated L.

Next in step S104, the CPU 31 irradiates the subject with the auxiliary light again in the lens position adjusted in the step S103 to detect the subject image signal. Thereafter, in step S105, the CPU 31 judges whether or not the contrast of the detected subject image signal is suitable for the focusing, that is, whether or not there is an effect of the auxiliary light irradiation. In the same manner as described with reference to FIG. 17, the effect can be judged by the contrast of the subject image signal.

When it is judged in the judgment of the step S105 that there is the effect of the auxiliary light irradiation, the mountain climbing AF of and after step S106 is performed. In this mountain climbing AF, first in step S106, the photographing lens 35 is driven by a micro amount, and the subject is irradiated with the micro amount of auxiliary light in this state in step S107. Thereafter, in step S108, the CPU 31 detects the contrast.

Next, in step S109, the CPU 31 judges again whether or not the contrast of the subject image signal detected in the step S108 is suitable for the focusing, that is, whether or not there is the effect of the auxiliary light irradiation. When it is judged in the judgment of the step S109 that there is the effect of the auxiliary light irradiation, the CPU 31 judges in step S112 whether or not the contrast is maximum. When it is judged in this judgment that the detected contrast is not maximum, the flow returns to the step S106 to continue the mountain climbing AF. On the other hand, when the contrast is judged to be maximum in the judgment of the step S112, the position is regarded as the focal position and the flow shifts to step S113.

Moreover, when it is judged in the judgment of the step S109 that the effect of the auxiliary light irradiation is eliminated, in step S110, the CPU 31 employs the main subject distance L calculated in the step S102 and obtained by the external metering AF as a distance for the focusing. Moreover, in step S111, after focusing the photographing lens 35 on L, the flow shifts to the step S113. When it is judged in the judgment of the step S105 that there is not the effect of the auxiliary light irradiation, the position adjusted in the step S103 is employed as the focal position as such, and the flow shifts to the step S113.

After ending the focusing of the photographing lens 35 by the above-described operation, the CPU 31 performs the exposure operation in the step S113 to record the photographed image.

As described above, according to the fourth embodiment, the effect of the auxiliary light is constantly monitored at the time of the mountain climbing AF. When the effect of the auxiliary light is eliminated, the AF is switched to the external metering AF in which priority is given to the speed.

Accordingly, without excessive energy consumption or without any time loss, the focusing can be performed at a high speed. Here, the scene requiring the irradiation with the auxiliary light includes a scene in which brightness becomes short or a scene with the low contrast. The irradiation with the auxiliary light is effective in accordance with the situation even in a nightscape scene or in a scene against the light.

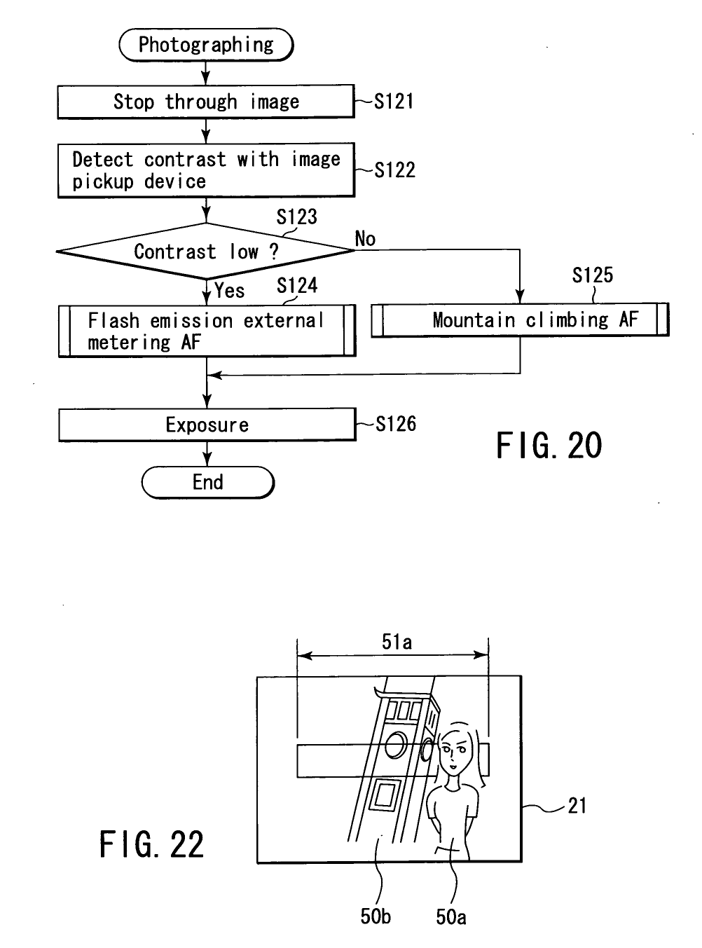

Moreover, in the example of FIG. 19, it is judged whether to switch to the external metering AF including the flash light projection and the mountain climbing AF based on the contrast of the subject image signal obtained by the sensor array. However, as in the example shown in FIG. 20, it may also be judged whether to switch to the external metering AF including the flash light projection and the mountain climbing AF based on the contrast of the subject image signal obtained by the image pickup device.

In this case, first in step S121, the CPU 31 stops acquisition of the image in the image pickup device 37. Moreover, in step S122, the contrast is detected from the subject image signal outputted from the image pickup device 37 at the time of the stop of the image acquisition. Next, the CPU 31 judges that the contrast is high/low in step S123.

When the contrast is judged to be low in this judgment, in step S124, the focusing is performed by the external metering AF in a state in which the light amount is compensated by the flash emission. Thereafter, the flow shifts to step S126. On the other hand, when the contrast is judged to be high in the judgment of the step S123, the flow shifts to the step S126 after performing the focusing by the mountain climbing AF in step S125.

After ending the focusing of the photographing lens 35, the CPU 31 performs the exposure operation in the step S126.

[Fifth Embodiment]

Prior to the description of a fifth embodiment, first an outline of the fifth embodiment will be described.

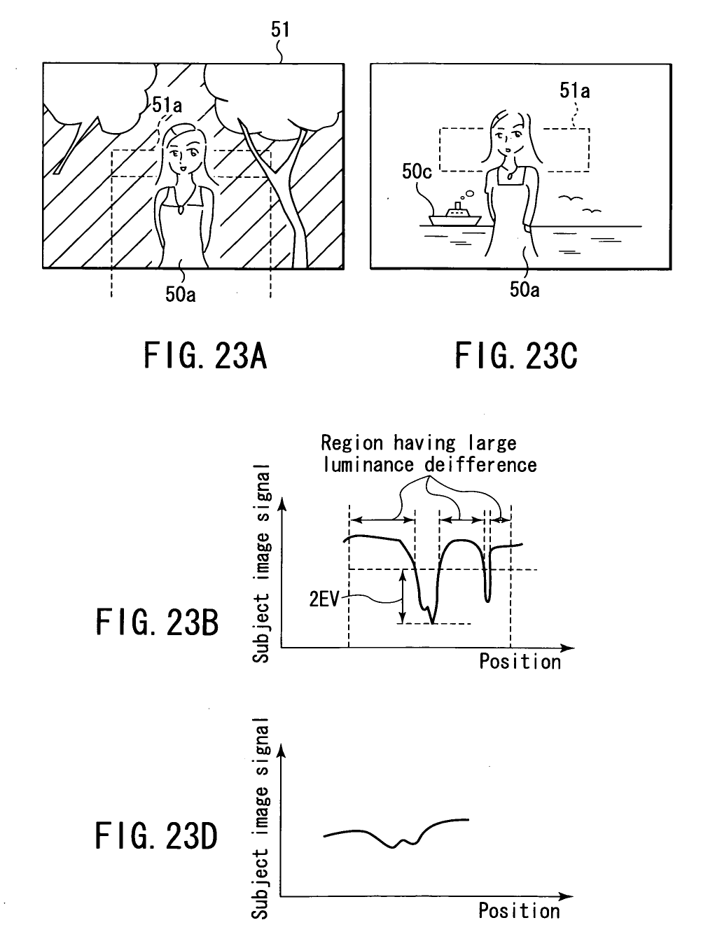

FIG. 23A shows a scene in which a person constituting the main subject exists in a photographing field middle part, and FIG. 23B shows one example of the subject image signal obtained by the external metering type distance-measuring device for monitoring a region 51a of the photographing field 51. At this time, when the background is dark and the main subject 50a is bright, a large amplitude change is seen in the subject image signal. It is difficult to control the exposure of the subject including a large amplitude of the subject image signal, that is, a large brightness change by a digital camera which has a narrow latitude.

Therefore, complete exposure control is considered to be necessary with respect to this scene. Therefore, it is necessary to execute the exposure control using all dynamic ranges of the image pickup device such as CCD. Then, in this case, without performed processing such as sensitization, the mountain climbing AF is preferably used in performing the focusing further in a state in which a diaphragm of the photographing lens is also opened.

However, in the mountain climbing AF, while the photographing lens is moved, the contrast of the image is judged. Therefore, much time is required in starting and stopping the photographing lens. As a result, the release time lag lengthens. Furthermore, even with the digital camera, the focusing by the mountain climbing AF system is not necessarily required. That is, it is not very preferable to use the mountain climbing AF depending on the photographing scene in some case.

For example, it is position to perform the sensitization process in a scene in which the brightness is substantially uniform as in FIG. 23C. Then, in this case, the sensitization process is performed, further a focal depth is increased depending on the diaphragm to perform the photographing, and it is preferable to perform the photographing in which priority is given to the reduction of the time lag rather than to the precision of the focus. Furthermore, even when there is a moving subject like a boat 50c in the background, the priority is to be given to the photographing speed.

This situation frequently occurs during travel. In this case, since the photographing has a high value as a record of memory rather than as a purpose, the photographing may be ended in a time as short as possible.

Moreover, from a viewpoint as the record of the memory, even when a slight lens position error is generated as described above, the photographing is satisfactory for the user as long as a change of a momentary facial expression of the person constituting the subject or the whole atmosphere is correctly reproduced. When the person is focused in a time more than necessary in this photographing, needless to say, a shutter chance is missed.

Furthermore, there is no problem when the subject in the background is stationary. However, for example, in the photographing of a scene in which the boat 50c passes over as shown in FIG. 23C, when too much time is taken in the photographing, the boat 50c sometimes comes out of a photographing range.

To solve the problem, in the fifth embodiment, the scene in which the priority is to be given to the reduction of the release time lag is judged by the brightness distribution in the photographing field to perform the focusing. Here, the external metering AF is used in this focusing. In the external metering AF, even when a view angle changes on a telephoto side or on a wide angle by zooming, the sensor array monitors the same position.

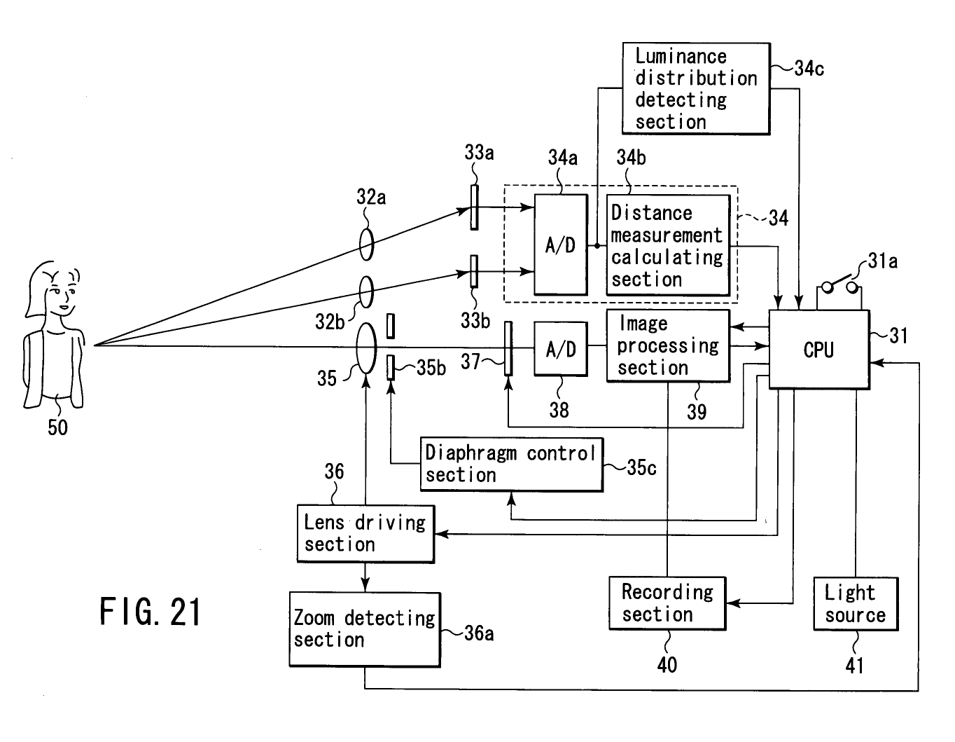

FIG. 21 is a block diagram showing the constitution of the electric signal of the camera in the fifth embodiment of the present invention. That is, this camera is constituted of the microprocessor (CPU) 31, the light receiving lenses 32a and 32b, the sensor arrays 33a and 33b, the distance-measuring section 34, the photographing lens 35, a diaphragm 35b, a diaphragm control section 35c, the LD section 36, the image pickup device 37, the A/D converting section 38, the image processing section 39, and the recording medium 40. Here, the constitution similar to that of FIG. 11 is denoted with the same reference numerals and the description thereof is omitted. Only a part different from that of FIG. 11 will be described.

In the same manner as in FIG. 11, the distance-measuring section 34 of the fifth embodiment is constituted of the A/D converting section 34a and distance measurement calculating section 34b. The A/D converting section 34a in the distance-measuring section 34 converts the subject image signals inputted from the sensor arrays 33a and 33b to the digital signals to output the signals to the distance measurement calculating section 34b. The distance measurement calculating section 34b calculates the distance to the subject 50 from the camera, that is, the short distance based on the digital signal in accordance with the principle of the triangular distance measurement. Here, in the fifth embodiment, the brightness distribution can be detected from the result of the A/D conversion by the A/D converting section 34a. This operation is performed by a brightness distribution detecting section 34c shown in FIG. 21.

In the image processing section 39, after correcting the color or gradation of the image based on the inputted digital signal, the image signal is compressed. In the fifth embodiment, the image processing section 39 also performs the sensitization process. To perform the sensitization process, the CPU 31 limits an image accumulated amount of the image pickup device 37, and amplifies/emphasizes the limited output of the image pickup device 37 in the image processing section 39.

A light source 41 projects the auxiliary light for the exposure or the distance measurement to the subject 50 in accordance with the photographing scene.

Moreover, in the fifth embodiment, the diaphragm 35b is disposed in the optical system constituting the photographing lens 35, and this diaphragm 35b controls the amount of the light incident upon the image pickup device 37. The diaphragm control section 35c controls the diaphragm 35b. Furthermore, in the zoom lens type camera including a zoom optical system in a photographing lens system, in addition to the above-described constitution, the zoom position detecting section 36a for detecting the position of the zoom lens is disposed.

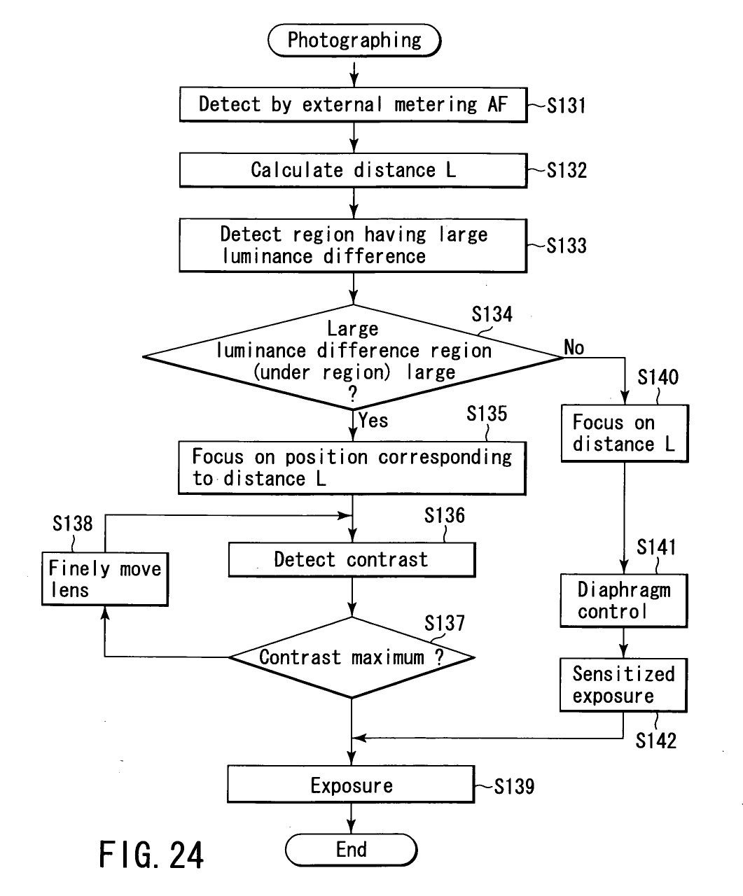

Next, the photographing control of the camera in the fifth embodiment will be described with reference to FIG. 24.

First, the CPU 31 detects the subject image signal by the external metering AF in step S131. To perform the detection, integrated values of outputs of the respective sensors constituting the sensor arrays 33a and 33b are detected. Here, the subject image signals, for example, shown in FIG. 23B or 23D are detected here. Here, in these drawings, the integration amount is large, that is, the part is bright in a lower direction. Next, in step S132, the CPU 31 calculates the distances of a plurality of points from the detected subject image signals. Moreover, for example, the shortest distance is selected from the calculated distances of the plurality of points. This distance has a high possibility that the main subject exists in this distance.

Next in step S133, the CPU 31 uses the level of the subject image signal of the point for outputting the main subject distance L as a standard to detect a region where a difference between the level and brightness is not less than the predetermined amount, that is, a region where the image signal having a value not more than the predetermined value with respect to the reference level exists. For example, a region whose brightness is 2 EV or more, that is, a region where the subject image signal having a level of ¼ of the reference level exists is detected. Then, a region shown as a “large brightness difference region” in FIG. 23B is detected.

Next, in step S134, the CPU 31 judges whether or not the large brightness difference region (under region) occupies a large ratio with respect to a subject image signal distribution. In this judgment, for example, the number of sensors which output the subject image signal having a level not more than the predetermined amount with respect to the reference level obtained in the step S133 is counted, and it may be judged whether the number of sensors is not less than the predetermined number. Here, it is judged whether 100 or more sensors in all 200 sensors are darker than the brightness of the main subject by 2 EV or more.

In the judgment of the step S134, the large brightness difference region (under region) occupies a large ratio with respect to the whole subject image signal distribution. That is, when 100 or more sensors in all the 200 sensors are judged to be dark, there is many dark parts with respect to the whole photographing field. Therefore, when the whole level of exposure is reduced, the dark part is brought to a noise level. Therefore, after the amplification of the subject image signal, even a random noise is unnaturally reproduced, and a remarkably undesirable image is obtained. Therefore, in this case, the photographing by usual exposure is preferable, the diaphragm is slightly opened, and a sufficient amount of light is guided into the image pickup device to perform the photographing. This is more preferable from color reproducibility. Here, in this case, since the focal depth decreases, the focusing is performed using the mountain climbing AF not influenced by the positional error by the driving of the photographing lens.

That is, the CPU 31 first focuses the photographing lens 35 on the vicinity of the main subject distance L calculated by the external metering distance-measuring device in step S135, and detects the contrast of the subject image signal in step S136. Next in step S137, the CPU 31 judges whether or not the detected contrast is maximum. When the detected contrast is judged not to be maximum in the judgment in the step S137, the CPU 31 drives the photographing lens 35 by a micro amount in step S138, and thereafter returns to the step S136 to continue detecting the contrast. On the other hand, when the detected contrast is judged to be maximum in the judgment in the step S137, usual exposure is performed in step S139, and the photographing control of this flowchart ends.

On the other hand, in the judgment of the step S134, it is judged that the large brightness difference region (under region) does not occupy the large ratio with respect to the whole subject image signal distribution, that is, 100 or more sensors in all the 200 sensors are not dark. In this case, there is little change of the brightness in the scene shown in FIG. 23C. In this situation, it is also easy to dispose all the images in the dynamic range of the image pickup device. That is, in this case, even when the electrical amplification process is performed after reducing the exposure, a degree of deterioration of the image is small. Therefore, in this case, it is possible to narrow down the diaphragm and increase the focal depth. Accordingly, an allowance of precision is generated even in AF, and therefore the external metering AF in which the priority is given to the speed is used in the focusing.

Moreover, in this case, the focal depth is increased to perform the photographing. Therefore, a subsidiary effect that the photograph can be taken while focusing on the main subject together with the background can also be expected. Furthermore, the photographing is possible in which the color reproducibility is satisfactory without any problem in the exposure as described above.

That is, when the large brightness difference region (under region) is judged not to occupy the large ratio with respect to the whole image signal distribution in the judgment of the step S134, in step S140, the CPU 31 focuses the photographing lens 35 onto the main subject distance L calculated in the step S132. Thereafter, after narrowing down the diaphragm 35b in the subsequent step S141, the CPU 31 performs sensitized exposure in step S142 to end the photographing control of this flowchart.

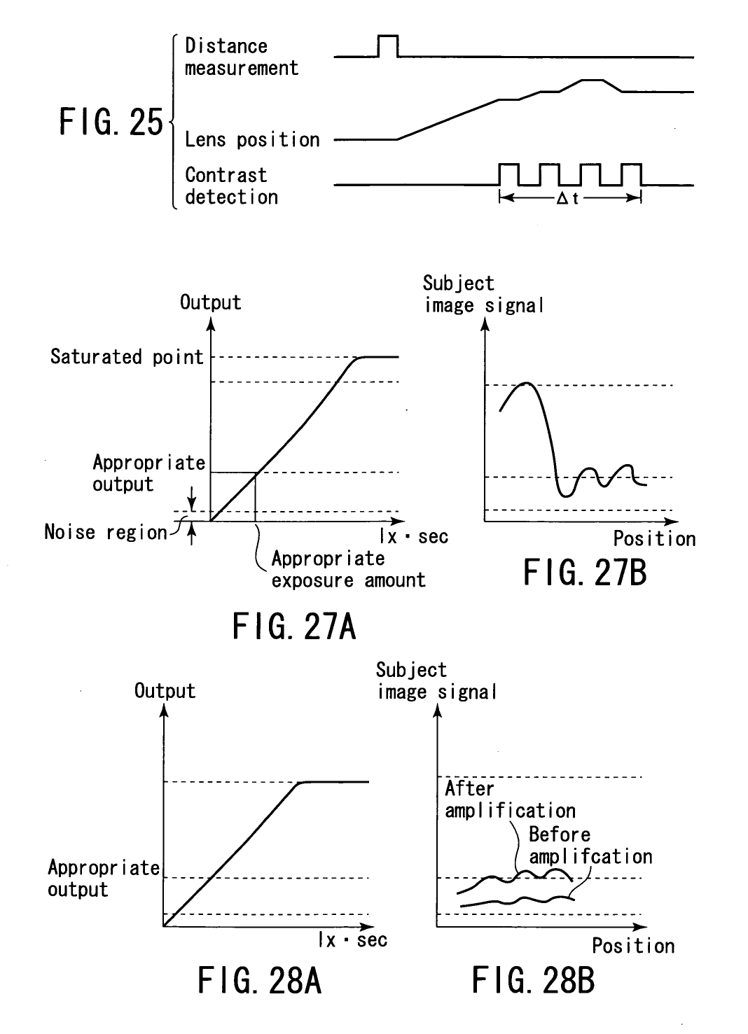

FIG. 25 is a timing chart at the time of the photographing in the fifth embodiment.

When the focusing is performed by the external metering AF, the distance measurement is performed, the lens is driven once, and the photographing ends. Therefore, a time for detecting the contrast as in the mountain climbing AF and for accordingly moving the lens is unnecessary. Therefore, in the external metering AF, the release time lag is reduced by Δt as compared with the mountain climbing AF in which the distance measurement and the driving of the lens a plurality of times are required.

As described above, in a general snap scene in which the background is bright and the subject is also bright as shown in FIG. 23C, the external metering AF can be used to perform the focusing at the high speed. On the other hand, in the scene in which the background is dark as shown in FIG. 23A, the dynamic range of the image pickup device such as CCD is sufficiently used by the mountain climbing AF, and it is possible to reproduce deep colors. Moreover, in this case, when the diaphragm is opened, the background is separated from the person, and the person can also be focused.

As described above, according to the fifth embodiment, the photographing can be performed with a high degree of user's satisfaction in accordance with the photographing scene.

[Sixth Embodiment]

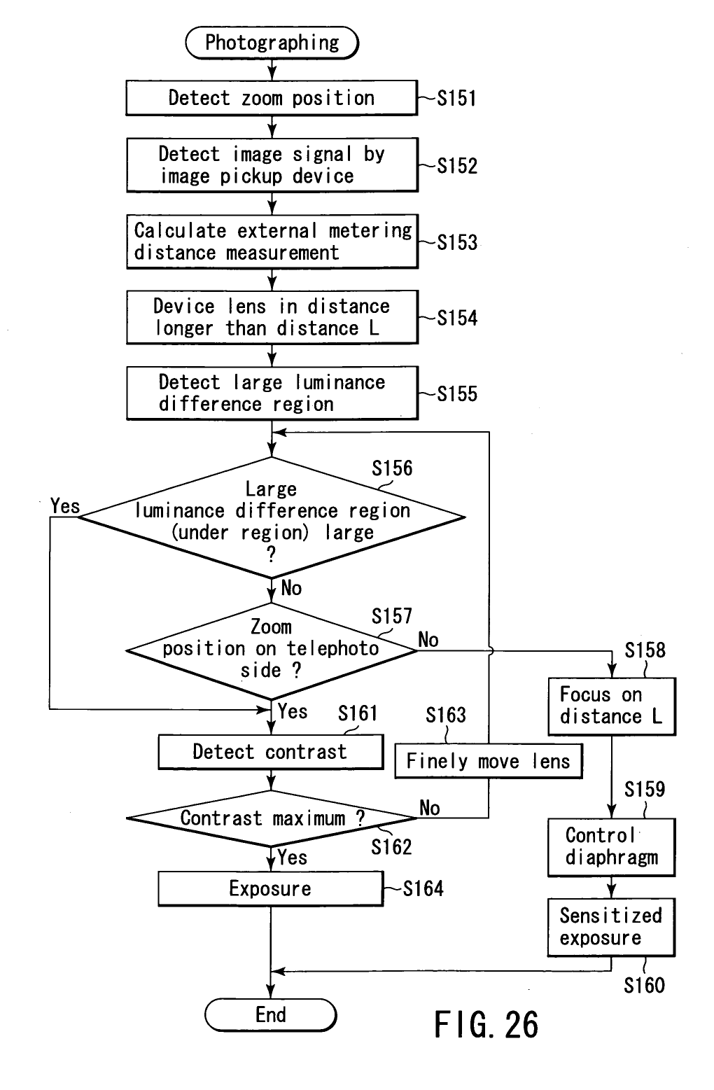

The flowchart of the photographing control of the camera in a sixth embodiment of the present invention is shown in FIG. 26. The sixth embodiment shows an example in which the camera including the zoom optical system is assumed in the photographing lens system.

Moreover, this is different from the fifth embodiment in that the output of the image pickup device for the photographing is used to judge whether or not the photographing can be performed by the external metering AF also using the sensitization process. Here, in the same manner as in the fifth embodiment, the sensitization process is performed in a scene in which the brightness difference is small and there is only a small dark part. Furthermore, in the sixth embodiment, it is judged whether or not to perform the sensitization process depending on the zoom position to judge the scene in detail.

That is, in the zoom on the side of the wide angle, a frequency at which the snap photograph is taken is high as compared with the zoom on the telephoto side, and it is therefore preferable to give priority to the reduction of the release time lag. Moreover, on the side of the wide angle, the focal depth is large, and the image is not out of focus even with a slight lens position error. Therefore, when the photographing is performed with the zoom on the side of the wide angle, the external metering AF is performed with a combined use with the sensitization process.

Moreover, to adjust a distance measurement range of the external metering distance-measuring device in accordance with the change of the view angle by the change of the position of the zoom lens, the distance measurement range needs to be changed in accordance with the position of the zoom lens. However, in the sixth embodiment, a brightness/darkness difference is judged by the output of the image pickup device to adjust the distance measurement range of the external metering distance-measuring device in accordance with the image angle change by the zooming.

In consideration of the above-described respect, in the flowchart of FIG. 26, first in step S151, the CPU 31 detects the zoom position by the zoom position detecting section 36a. Next in step S152, the CPU 31 uses the image pickup device 37 to detect the subject image signal. In step S153, the CPU 31 calculates the main subject distance L by the external metering AF. Next in step S154, the CPU 31 drives the photographing lens 35 so that adjust the focus in a distance slightly longer than the calculated subject distance L.

Next in step S155, the CPU 31 detects a region where the brightness distribution is not less than the predetermined amount in the subject image signal detected in the step S151. Moreover, from the result, it is judged in step S156 whether or not the large brightness difference region (under region) occupies the large ratio with respect to the whole distribution. Here, the judgment may be performed by a method similar to that of the fifth embodiment. That is, the predetermined number or more sensors constituting the image pickup device 37 issue an output having a level which is not more than the predetermined level. In this case, the large brightness difference region (under region) is judged to be large.

When the large brightness difference region (under region) is judged to be large, it is detected in step S157 whether or not the zoom position detected in the step S151 is on the telephoto side. When the zoom position is judged not to be on the telephoto side, that is, to be on the side of the wide angle, in step S158, the CPU 31 adjusts the focus with respect to the subject distance L calculated in the step S153. This indicates the scene in which the background and main subject have substantially uniform brightness as in FIG. 23C. In this case, the sensitization process can be performed. Then, in step S159, after narrowing down the diaphragm 35b, the CPU 31 performs the sensitized exposure in step S160. Thereafter, the photographing control of this flowchart is ended. In this case, since the focusing is performed in the external metering AF, it is possible to reduce the release time lag.

On the other hand, when the large brightness difference region (under region) is judged to be small in the judgment of the step S156, or when the zoom position is judged to be on the telephoto side in the judgment of the step S157, the flow shifts to step S161. In this case, when the sensitization process is performed, noise is generated, or the focus is sometimes influenced by the lens position error. Therefore, the mountain climbing AF is performed. That is, in this case, in step S161, the CPU 31 detects the contrast of the subject image signal. Next in step S162, the CPU 31 judges whether or not the detected contrast is maximum. When it is judged that the detected contrast is not maximum in the judgment of the step S162, the photographing lens 35 is driven slightly in the step S163, and the flow returns to the step S156.

On the other hand, when the detected contrast is judged to be maximum in the judgment of the step S162, the CPU 31 ends the photographing control of this flowchart after performing the exposure operation in step S164.

As described above, according to the sixth embodiment, the zoom position is considered, and it is possible to more correctly judge whether or not the sensitized exposure can be performed using the output of the image pickup device.

Here, the sensitized exposure process for use in the fifth and sixth embodiments will be described.

FIGS. 27A, 28A, and 29A show output characteristics of the image pickup devices such as CCD. Here, 0×·sec obtained by multiplying the amount of the light incident upon the image pickup device by an incidence time is shown on the abscissa, the image pickup device output is shown on the ordinate, and a characteristic of a proportional relation is shown until a predetermined time elapses from the start of the incidence. However, the dynamic range of the image pickup device is limited. Therefore, when the image pickup device output reaches a predetermined saturated level, and even when the light is further applied, the output does not change.

Therefore, it is preferable to perform the exposure (i.e., the control of the incidence time of the light incident upon the image pickup device 37) so that a brightest part in the photographing field is within the predetermined saturated level. Here, when the brightest part is within the saturated level in FIG. 27B, and the exposure control is performed so as to obtain an appropriate output of the main subject, the exposure of the main subject is controlled to be performed in about ¼ to ⅕ of the saturated level. The exposure amount for the main subject to obtain the appropriate output is referred to as an “appropriate exposure amount” herein. For the camera, so as to expose the main subject with the appropriate exposure amount, a shutter (not shown) is controlled so that the exposure time is shortened in the bright scene to reduce the exposure amount or the exposure time is lengthened in the dark scene to increase the exposure amount.

It is to be noted that examples of the shutter include a mechanical shutter for mechanically covering the image pickup device and an electronic shutter for electronically cutting off the output of the image pickup device, but either shutter may also be used in both the fifth and sixth embodiments.

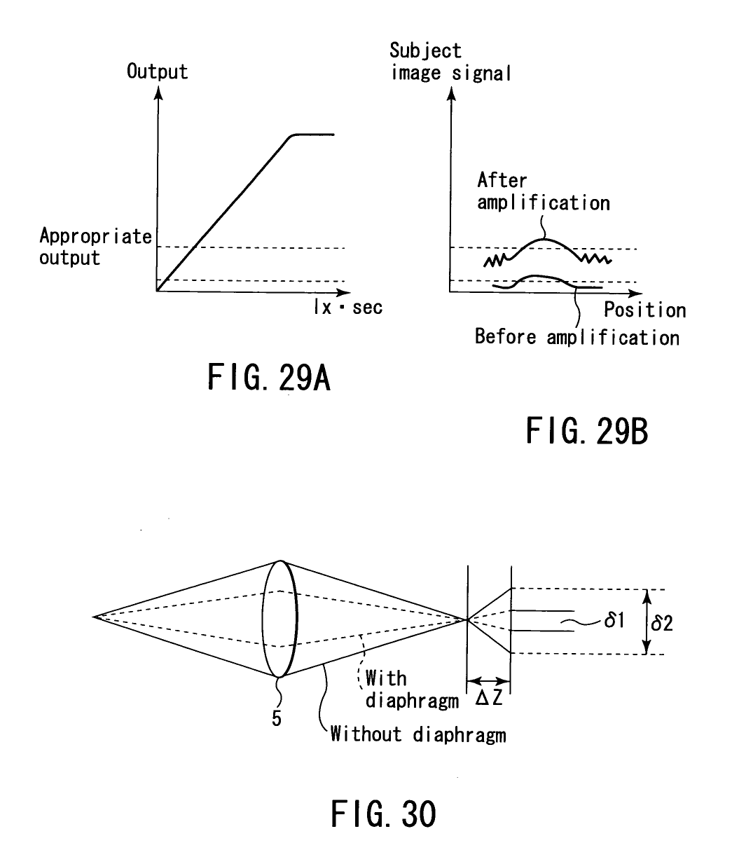

Moreover, the subject image signal on a low brightness side is preferably prevented from entering a noise region shown in FIG. 27A. That is, even when the light doesn't enter the image pickup device, the noise is generated. Therefore, with a small amount of signals that can be obtained with a small exposure amount, noise components cannot be distinguished from signal components. Therefore, when the subject image signal is in a region not more than the noise region before the amplification as shown in FIG. 29B, the noise is mixed even in the amplified signal, and a random color noise is generated.

The sensitization process is a technique for performing the amplification process to produce an appropriate image. However, even when the sensitization process is performed as shown in FIG. 29B, it is difficult to obtain a beautiful image. Especially when the image including a large dark part is subjected to the sensitization process, the noise is generated in a large part of the photographing field. Then, in the sixth embodiment, as shown in FIG. 28B, the sensitization process is performed only in a scene in which the subject image signal does not enter the noise region.

Moreover, as described above, the exposure amount is determined by an aperture value and exposure time. When diaphragm 35b is narrowed down, the amount of the light incident upon the image pickup device 37 is reduced, and the sensitization process is required. When the diaphragm 35b is narrowed down, as shown in FIG. 30, a blur amount δ is small with respect to a focus error AZ of the photographing lens 35.

For example, a blur amount is indicated with δ₂ in a case where the diaphragm 35b is opened as shown in FIG. 30, and then the blur amount with the narrowed-down diaphragm 35b indicates δ₁ which is smaller than δ₂. By this function, when the diaphragm 35b is narrowed down even in the external metering AF, the error of the focus can be reduced.

Therefore, in the above-described fifth and sized embodiments, the sensitized exposure is performed only when a difference of brightness between the main subject and the other part is small as shown in FIG. 28B. At this time, the diaphragm 35b is narrowed down, and further the external metering AF is also used to improve the time lag. On the other hand, in the scene where the noise is conspicuous when performing the sensitization process as shown in FIG. 29B, without performing the control, the focusing is performed without any error in the focal position in the mountain climbing AF.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A focusing apparatus comprising:
a distance-measuring device which measures distances of a plurality of points in a photographing field;
a photographing lens;
a driving mechanism which drives the photographing lens along an optical axis;
an image pickup device which receives a subject light flux incident via the photographing lens to output a subject image signal; and
a CPU which controls the driving mechanism to drive the photographing lens along the optical axis, while detecting a contrast of the subject image signal in a plurality of image pickup areas corresponding to the plurality of points and which adjusts a focal position of the photographing lens in a position which has a highest contrast of the subject image signal in an image pickup area corresponding to a point indicating a shortest distance of an output of the distance-measuring device in the plurality of points.

2. The apparatus according to claim 1, wherein the distance-measuring device detects a brightness in the plurality of points, and the image pickup device sets an integration time in the plurality of image pickup areas based on the detected brightness.

3. A focusing apparatus comprising:
a distance-measuring device which measures distances of a plurality of points in a photographing field;
a photographing lens;
a driving mechanism which drives the photographing lens along an optical axis;
an image pickup device which receives a subject light flux incident via the photographing lens to output a subject image signal;
an image processing section which processes the subject image signal outputted from the image pickup device; and
a CPU which selects the specific area based on a part of an output of the distance-measuring device and which operates the driving mechanism to execute a mountain climbing AF operation in accordance with a contrast of the subject image signal in a specific area.

4. The apparatus according to claim 3, wherein the CPU selects the specific area based on the output of the distance-measuring device excluding an output indicating a longest distance.

5. A focusing apparatus comprising:
an image pickup device including a plurality of image pickup areas;
a focusing lens including an optical path via which a subject light flux is incident upon the image pickup device;
a focusing section which determines a plurality of focusing lens positions from a relation between the position of the focusing lens and a contrast of a subject image signal obtained on the image pickup device via the focusing lens;
a distance-measuring section which obtains the position of a subject in a photographing field and a distance to the subject by the subject light flux incident via an optical path different from that of the focusing lens; and
a calculation control section which obtains a plurality of combinations of the focusing lens position and the image pickup area for use at the time of the focusing by the position and distance of the subject obtained by the distance-measuring section.

6. The apparatus according to claim 5, further comprising: a control section which stops the focusing lens in the plurality of focusing lens positions in accordance with the plurality of combinations and which obtains the contrast of the subject image signal outputted from the image pickup area of the combination corresponding to each focusing lens position and the contrast of the subject image signal outputted from the image pickup device in all the areas of the image pickup device to determine the position of the focusing lens.

7. The apparatus according to claim 5, wherein the distance-measuring section includes a divided sensor array, and determines charge accumulation conditions of the image pickup device at the time of the obtaining of a change in the contrast by the output of the sensor array disposed in the distance-measuring section.

8. A focusing apparatus comprising:
a photographing lens;
an image pickup section which detects a subject image incident via the photographing lens;
an optical system which is different from the photographing lens;
a distance-measuring section which uses the optical system different from the photographing lens to measure a subject distance of a plurality of points in a photographing field; and
a determining section which focuses the photographing lens on a plurality of focal positions corresponding to a plurality of distance measurement results of the distance-measuring section and which determines an area to execute a mountain climbing AF based on contrasts obtained at the plurality of focal positions and the distance measurement results.

9. A camera including a focusing apparatus, comprising:
an irradiation device which selectively switches irradiation and non-irradiation of a subject with an auxiliary light for distance measurement;
a photographing lens;
a driving circuit which drives the photographing lens along an optical axis direction;
an image pickup device which receives a light flux incident from the subject via the photographing lens to output a subject image signal;
an image processing circuit which processes the subject image signal outputted from the image pickup device;
a distance-measuring device which includes a pair of optical systems and a pair of sensors for distance measurement to detect a plurality of subject images incident via the pair of optical systems and which outputs information associated with a subject distance based on the plurality of subject images detected by the sensors for distance measurement and which detects the plurality of subject images in a case where the subject has a low brightness; and
a CPU which selectively executes a first auto-focus operation of detecting a contrast state based on the subject image signal processed by the image processing circuit to adjust a focus of the photographing lens, a second auto-focus operation of performing a distance-measuring operation by the distance-measuring device in a non-irradiation state of the auxiliary light for distance measurement to adjust the focus of the photographing lens in accordance with a result of the distance-measuring operation, and a third auto-focus operation of performing the distance-measuring operation by the distance-measuring device in an irradiation state of the auxiliary light for distance measurement to adjust the focus of the photographing lens in accordance with the result of the distance-measuring operation.

10. The camera according to claim 9, wherein the CPU judges whether or not the subject indicates the low brightness and executes any of the first, second, and third auto-focus operations in accordance with the result of the judgment.

11. The camera according to claim 10, wherein the CPU executes the second auto-focus operation and judges that the subject indicates the low brightness, when the output of the sensors for distance measurement indicate a level not more than a predetermined level as a result of the second auto-focus operation.

12. The camera according to claim 11, wherein the CPU executes the third auto-focus operation, when the subject is judged to indicate the low brightness.

13. The camera according to claim 9, wherein the CPU executes the second auto-focus operation, and executes the first auto-focus operation, when the subject is judged to exist in a distance shorter than a predetermined distance.

14. A camera including a focusing apparatus, comprising:
a photographing lens;
a first auto-focus section which adjusts a focus of the photographing lens based on a contrast of a subject image obtained via the photographing lens;
a pair of optical systems which are different from the photographing lens;
a second auto-focus section which adjusts the focus of the photographing lens based on a pair of subject images obtained via the pair of optical systems;
a flash light irradiating section which irradiates a subject with a flash light;
a judging section which judges whether or not an auto-focus operation by the first auto-focus section is appropriate; and
a control section which operates the first auto-focus section, when the judging section judges that the auto-focus operation by the first auto-focus section is appropriate and which operates both the second auto-focus section and the flash light irradiating section, when the judging section judges that the auto-focus operation by the first auto-focus section is inappropriate.

15. A camera including a focusing apparatus, comprising:
a photographing lens;
an image pickup device which acquires an image signal of a subject in a photographing field via the photographing lens at the time of photographing;
an optical system which is different from the photographing lens;
a distance-measuring section which uses the optical system different from the photographing lens to acquire a plurality of image signals and which obtains a distance of a main subject based on the acquired plurality of image signals prior to the photographing;
a projecting section which emits a light to the main subject in a case where the plurality of image signals acquired by the distance-measuring section are inappropriate for an operation of obtaining the main subject distance by the distance-measuring section; and
a control section which controls a focus of the photographing lens in accordance with the distance of the main subject obtained by the distance-measuring section with the emission of the projecting section and which determines whether or not to continuously control the focus by a contrast change of the image signal outputted from the image pickup device with a focal position movement of the photographing lens.

16. A camera including a focusing apparatus, comprising:
a photographing lens;
an image pickup device which acquires a subject image signal via the photographing lens;
a first focusing control section which detects a contrast of the subject image signal acquired by the image pickup device to control the focusing of the photographing lens based on the detected contrast;
a projecting section which projects a light to a subject;
an optical system for distance measurement which acquires a plurality of subject image signals different from the subject image signal acquired by the image pickup device during the projection by the projecting section;
a distance-measuring section which obtains a subject distance based on the plurality of subject image signals acquired via the optical system for distance measurement;
a second focusing control section which controls the focusing of the photographing lens based on the subject distance obtained in the distance-measuring section; and
a determining section which determines whether to control the focusing by the first focusing control section or the second focusing control section in accordance with the subject distance obtained by the distance-measuring section.

17. The camera according to claim 16, wherein the projecting section is a flash light irradiating section which irradiates the subject with a flash light.

18. The control according to claim 16, wherein the distance-measuring section acquires a pair of subject image signals via the optical system for distance measurement and obtains the subject distance from a phase difference between the pair of subject image signals.

19. The camera according to claim 16, wherein the distance-measuring section includes a detecting section which detects a contrast of the pair of subject image signals acquired via the optical system for distance measurement, and
the determining section repeats the projection by the projecting section while controlling the focusing by the first focusing control section, when the subject distance obtained by the distance-measuring section is shorter than a predetermined value and when the contrast obtained by the detecting section is larger than the predetermined value.

20. The camera according to claim 16, wherein the distance-measuring section includes a detecting section which detects a contrast of the pair of subject image signals acquired via the optical system for distance measurement,
the camera including the focusing apparatus further comprising: a third focusing control section which controls the focusing of the photographing lens based on an amount of a reflected light of the light projected onto the subject by the projecting section, when the contrast detected by the detecting section is smaller than a predetermined value.

21. A camera including a focusing apparatus, comprising:
a photographing lens;
an image pickup device which acquires a subject image signal via the photographing lens;
a first auto-focus section which performs focusing of the photographing lens based on a contrast of the subject image signal acquired by the image pickup device;
a pair of optical systems which are different from the photographing lens;
a distance-measuring device which uses a pair of subject image signals acquired via the pair of optical systems to perform distance measurement;
a second auto-focus section which performs the focusing of the photographing lens in accordance with a distance measurement result of the distance-measuring device;
a flash light irradiating section which irradiates a subject with a flash light;
a judging section which judges whether or not the pair of subject image signals obtained via the pair of optical systems or the subject image signal acquired by the image pickup device is appropriate for a distance-measuring operation of the distance-measuring device; and
a control section which irradiates the subject with the flash light in accordance with a judgment result of the judging section by the flash light irradiating section and which performs the focusing of the photographing lens preferentially by the second auto-focus section.

22. A camera including a focusing apparatus, comprising:
a flash section which irradiates a subject with an auxiliary light;
a photographing lens;
a contrast type focusing section which acquires a subject image signal at the time of displacement of the photographing lens by a micro amount via the photographing lens and which determines a focusing position in accordance with a contrast change of the acquired subject image signal to control the focusing of the photographing lens;
an optical system which is different from the photographing lens;
a distance-measuring section which acquires a plurality of subject image signals via the optical system different from the photographing lens to measure a distance of the subject based on the acquired plurality of subject image signals; and
a control section which determines whether to continue focusing control by the contrast type focusing section or to change to the focusing control to determine the focusing position based on the distance measured by the distance-measuring section, based on the plurality of subject image signals acquired by the distance-measuring section when the subject is irradiated with the auxiliary light by the flash section.

23. The camera according to claim 22, wherein the control section controls the irradiation of the subject with the auxiliary light by the flash section and controls the focusing by the contrast type focusing section, when the distance of the subject measured by the distance-measuring section is shorter than a predetermined value at the time of the irradiation with the auxiliary light by the flash section, and the contrast of the plurality of subject image signals acquired by the distance-measuring section is larger than a predetermined value.

24. A camera including a focusing apparatus, comprising:
a photographing lens;
a driving mechanism which drives the photographing lens along an optical axis direction;
an image pickup device which receives a subject light flux incident via the photographing lens to output the subject image signal;
an image processing circuit which processes the subject image signal outputted from the image pickup device;
a distance-measuring device which includes a pair of optical systems and a pair of sensors for distance measurement to detect a pair of subject images incident via the pair of optical systems and which outputs information associated with a subject distance based on the subject images detected by the sensors for distance measurement; and
a CPU which detects the subject image signal processed by the image processing circuit or a brightness distribution of the pair of subject images detected by the sensors for distance measurement to select either one of the first and second auto-focus operations based on the detection result and which selectively executes a first auto-focus operation of detecting a contrast based on the subject image signal processed by the image processing circuit to adjust a focus of the photographing lens, and a second auto-focus operation of performing a distance-measuring operation by the distance-measuring device to adjust the focus of the photographing lens in accordance with a result of the distance-measuring operation.

25. A camera including a focusing apparatus, comprising:
a photographing lens including a diaphragm mechanism;
an image pickup section which includes an image pickup device to photograph a subject image incident via the photographing lens to obtain a subject image signal;
a setting section which sets conditions of an image pickup operation by the image pickup section;
a first auto-focus section which focuses the photographing lens from a contrast of the subject image signal obtained by the image pickup section;
a pair of optical systems for distance measurement which are different from the photographing lens;
a distance-measuring section which includes a pair of sensors for distance measurement to acquire a pair of subject image signals via the pair of optical systems for distance measurement and which performs a distance-measuring operation to calculate a subject distance from the pair of subject image signals;
a second auto-focus section which focuses the photographing lens based on the distance measurement result of the distance-measuring section;
a selecting section which detects the subject image signal obtained by the image pickup device or a brightness distribution of the pair of subject image signals obtained by the sensors for distance measurement to select either one of the first and second auto-focus sections in accordance with a ratio of a low-brightness portion in the detected brightness distribution; and
a change section which changes the conditions of the distance-measuring operation set by the setting section, when the selecting section selects the second auto-focus section.

26. The camera according to claim 25, wherein the conditions of the image pickup operation set by the setting section include at least aperture value information of the diaphragm mechanism, shutter speed information of a shutter to expose an image pickup plane of the image pickup device, and sensitivity information of the image pickup device.

27. The camera according to claim 26, wherein the change section changes the aperture value information and the sensitivity information set by the setting section.

28. The camera according to claim 27, wherein the change section the aperture value information so as to narrow down the diaphragm mechanism by a value larger than that in the aperture value information set by the setting section and changes the sensitivity of the image pickup device so as to raise the sensitivity of the image pickup device.

29. A camera including a focusing apparatus, comprising:
a photographing lens;
a first auto-focus section which includes an image pickup device to obtain a contrast of a subject image signal obtained via the photographing lens and which adjusts a focus of the photographing lens based on the contrast of the subject image signal obtained by the image pickup device;
a pair of optical systems which are different from the photographing lens;
a second auto-focus section which includes a distance-measuring device to perform a distance-measuring operation based on a pair of subject image signals obtained via the pair of optical systems and which adjusts the focus of the photographing lens in accordance with the output of the distance-measuring device;
a detecting section which detects the subject image signal obtained by the image pickup device or a brightness distribution of the pair of subject image signals obtained by the distance-measuring device; and
a change section which selects the second auto-focus section in accordance with a ratio of a low-brightness portion of a brightness distribution detected by the detecting section and which changes an aperture value of the diaphragm mechanism in the photographing lens and a sensitivity of the image pickup device.

30. A camera including a focusing apparatus, comprising:
a photographing lens;
an optical system which is different from the photographing lens;
a distance-measuring section which acquires a plurality of subject image signals via the optical system different from the photographing lens prior to a photographing operation to obtain a distance of a main subject based on the acquired plurality of subject image signals; and
a judging section to judge a scene in which sensitized photographing is possible by a brightness change in the plurality of subject image signals acquired by the distance-measuring section, the judging section controlling focusing of the photographing lens in accordance with the distance of the main subject obtained by the distance-measuring section and changing a diaphragm of the photographing lens and a sensitization sensitivity at the time of the photographing, when judging the scene in which the sensitized photographing is possible.

31. A camera including a focusing apparatus, comprising:
a photographing lens including a zoom optical system;
an image pickup section which photographs a subject via the zoom optical system to obtain a subject image signal;
an optical system which is different from the photographing lens;
a distance-measuring section which acquires a plurality of subject image signals via the optical system different from the photographing lens to measure a subject distance based on the acquired plurality of subject image signals;
a first focusing control section which determines a focusing position of the photographing lens based on an output of the distance-measuring section;
a second focusing control section which determines the focusing position of the photographing lens based on a contrast change of the subject image signal acquired by the image pickup section, when the photographing lens is slightly driven;
a zoom position detecting section which detects the position of the zoom optical system; and
a selecting section which selects either one of the first and second focusing control sections in accordance with the position of the zoom optical system detected by the zoom position detecting section and a brightness change of the subject image signal acquired by the image pickup section.

32. The camera according to claim 31, wherein the selecting section selects the first focusing control section, when the position of the zoom optical system detected by the zoom position detecting section is on the side of a wide angle and a brightness change of the subject image signal acquired by the image pickup section is small.
